(19) United States
(12) Patent Application Publication
(10) Pub. No.: US 2026/0259914 A1
(43) Pub. Date: Sep. 3, 2026

(54) USING MACHINE LEARNING MODELS FOR INFORMATION RETRIEVAL DURING NON-TERRESTRIAL NETWORK COMMUNICATION

(71) Applicant: Google LLC, Mountain View, CA (US)

(72) Inventors: Shailesh Maheshwari, San Diego, CA (US); Ke Dong, San Jose, CA (US); Chinmay Dhodapkar, San Diego, CA (US)

(21) Appl. No.: 19/530,897

(22) Filed: Feb. 5, 2026

Related U.S. Application Data
(60) Provisional application No. 63/764,935, filed on Feb. 28, 2025.

(51) Int. Cl. G06F 16/335

(52) U.S. Cl. CPC G06F 16/335

(57) ABSTRACT

An example computing device connected with an accessible non-terrestrial network receives data indicative of a user input and determines whether an amount of the data exceeds a maximum amount of data that can be transmitted via the connection within a predetermined time frame. Responsive to determining the amount of the data exceeds the maximum amount of data, the computing device generates modified data by applying transformations to the data indicative of the user input. Responsive to determining an amount of the modified data does not exceed the maximum amount of data, the computing device transmits, to a computing system via the connection, the modified data and a prompt including context information for the computing device. The computing device receives, from the computing system, output generated by the computing system based on the modified data and the prompt. The computing device generates, for display, a user interface including the output.

### BACKGROUND

This application claims the benefit of US Provisional Patent Application No. 63/764,935, filed 28 February 2025, the entire contents of which is incorporated herein by reference.

Computing devices such as so-called smartphones, tablets, and the like may include one or more various wireless radios, transceivers, and antennas for establishing wireless communications with separate communications networks, including telephony networks, internet protocol (IP) based networks (e.g., the public Internet), private networks, and non-terrestrial networks (e.g., satellite communications networks), via which to receive and transmit data. The various transceivers and antennas may be configured as built-in modules integrated into the computing device or may optionally be externally configured components connected with the computing device via, for example, an externally facing data communications bus built into the computing device and configured to communicate with external peripheral devices.

### SUMMARY

In general, techniques of this disclosure are directed to enabling the efficient use of machine learning models, such as large language models, for information retrieval over non-terrestrial networks. An example computing device (e.g., a user computing device, such as a smartphone), may establish a connection with at least one accessible non-terrestrial network (e.g., a satellite communications network). While connected to the non-terrestrial network, the computing device may receive data indicative of at least one user input, e.g., a user query. For instance, a user may provide a natural language audio input such as, “Tell me about the capital of France and its population.” The computing device may determine whether an amount of the data exceeds a maximum amount of data that can be transmitted via the connection within a predetermined time frame (e.g., whether the query would require a bandwidth that exceeds the bandwidth of the non-terrestrial network connection). More specifically, the computing device may determine whether the satellite connection has enough available bandwidth to transmit the user query to a computing system, e.g., one or more ground-based servers, that can process, analyze, and provide output for the natural language audio input. For instance, the computing system may include a large language model capable of processing the natural language audio input. However, provided that bandwidth for satellite connections may be limited, the computing device may determine that the data indicative of the user input needs to be modified (e.g., reduced, compressed, summarized, etc.). As such, responsive to determining the amount of the data exceeds a maximum amount of data, the computing device may apply one or more transformations to the data to generate the modified data. A “transformation,” as used herein, refers to any process that modifies the data indicative of a user input and/or a generated response to reduce its size, change its format, or extract relevant features, while preserving sufficient information content for the remote computing system to generate a meaningful response.

In examples where an amount of the modified data does not exceed the maximum amount of data, the computing device may transmit, to the computing system and via the connection, the modified data. The computing device may receive, via the connection, at least one text output generated by the computing system based on the modified data. In some examples, the computing device may receive one or more additional user inputs associated with the same session identifier. In general, the computing device and the computing system may apply transformations such as context optimization to inputs and outputs associated with the same session identifier. That is, the computing device and computing system may use information stored for the session identifier to optimize and/or modify data indicative of any additional user inputs and responses provided during the session. For example, the computing device may transmit data to the computing system with the session identifier, such that the computing system can infer input and make assumptions using the information provided throughout the session as context. Continuing the example, the computing device may receive a second user input such as, “What is the GDP of Paris, the capital of France?” and generate a modified second user input such as, “What is its GDP?” The computing system may receive the modified second input and use, for instance, the first user input and the first text output to understand the context of the modified second input, and thus generate a second text output, such as “$1.064 trillion.” The computing device may generate, for display by a user interface device included in the computing device, the text outputs received from the computing system. The computing device may store the text outputs with the respective session identifier in a memory.

In one example, the techniques of this disclosure are directed to a method that includes establishing, by a computing device, a connection with at least one accessible non-terrestrial network, and receiving, by the computing device, data indicative of at least one user input. The method further includes determining, by the computing device, whether an amount of the data exceeds a maximum amount of data that can be transmitted via the connection within a predetermined time frame, and responsive to determining the amount of the data exceeds the maximum amount of data, generating, by the computing device, modified data by applying one or more transformations to the data indicative of the at least one user input. The method further includes, responsive to determining an amount of the modified data does not exceed the maximum amount of data, transmitting, by the computing device, and to a computing system via the connection, the modified data and a prompt, in which the prompt is indicative of context information for the computing device. The method further includes receiving, by the computing device, and via the connection, at least one text output generated by the computing system based on the modified data and the prompt, and generating, by the computing device, and for display by a user interface device included in the computing device, the at least one text output.

In another example, the techniques of this disclosure are directed to a computing device that includes one or more processors, and one or more storage devices that store instructions. The instructions, when executed by the one or more processors, cause the one or more processors to establish a connection with at least one accessible non-terrestrial network, and receive data indicative of at least one user input. The instructions further cause the one or more processors to determine whether an amount of the data exceeds a maximum amount of data that can be transmitted via the connection within a predetermined time frame, and responsive to determining the amount of the data exceeds the maximum amount of data, generate modified data by applying one or more transformations to the data indicative of the at least one user input. The instructions further cause the one or more processors to, responsive to determining an amount of the modified data does not exceed the maximum amount of data, transmit, to a computing system via the connection, the modified data and a prompt, in which the prompt is indicative of context information for the computing device. The instructions further cause the one or more processors to receive, via the connection, at least one text output generated by the computing system based on the modified data and the prompt, and generate, for display by a user interface device included in the computing device, the at least one text output.

In yet another example, the techniques of this disclosure are directed to a non-transitory computer-readable storage medium encoded with instructions. The instructions, when executed by one or more processors of a computing device, cause the one or more processors to establish a connection with at least one accessible non-terrestrial network, and receive data indicative of at least one user input. The instructions further cause the one or more processors to determine whether an amount of the data exceeds a maximum amount of data that can be transmitted via the connection within a predetermined time frame, and responsive to determining the amount of the data exceeds the maximum amount of data, generate modified data by applying one or more transformations to the data indicative of the at least one user input. The instructions further cause the one or more processors to, responsive to determining an amount of the modified data does not exceed the maximum amount of data, transmit, to a computing system via the connection, the modified data and a prompt, in which the prompt is indicative of context information for the computing device. The instructions further cause the one or more processors to receive, via the connection, at least one text output generated by the computing system based on the modified data and the prompt, and generate, for display by a user interface device included in the computing device, the at least one text output.

In yet another example, the techniques of this disclosure are directed to a computer program product for enabling information retrieval while connected with at least one accessible non-terrestrial network. The computer program product includes one or more instructions. The instructions, when executed by one or more processors of a computing device, cause the one or more processors to establish a connection with at least one accessible non-terrestrial network, and receive data indicative of at least one user input. The instructions further cause the one or more processors to determine whether an amount of the data exceeds a maximum amount of data that can be transmitted via the connection within a predetermined time frame, and responsive to determining the amount of the data exceeds the maximum amount of data, generate modified data by applying one or more transformations to the data indicative of the at least one user input. The instructions further cause the one or more processors to, responsive to determining an amount of the modified data does not exceed the maximum amount of data, transmit, to a computing system via the connection, the modified data and a prompt, in which the prompt is indicative of context information for the computing device. The instructions further cause the one or more processors to receive, via the connection, at least one text output generated by the computing system based on the modified data and the prompt, and generate, for display by a user interface device included in the computing device, the at least one text output.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 illustrates an example computing device configured to use non-terrestrial networks, in accordance with one or more techniques of this disclosure.

FIG. 2 is a block diagram illustrating another example computing device configured to use non-terrestrial networks, in accordance with one or more techniques of this disclosure.

FIG. 3A is a conceptual diagram illustrating an example training process for a machine learning module, in accordance with one or more techniques of this disclosure.

FIG. 3B is a conceptual diagram illustrating an example trained machine learning module, in accordance with one or more techniques of this disclosure.

FIG. 3C is a conceptual diagram illustrating a machine learning module configured to apply an on-device model, in accordance with one or more aspects of the present disclosure.

FIG. 4 is a block diagram illustrating another example computing device configured to use non-terrestrial networks, in accordance with one or more techniques of this disclosure.

FIG. 5 is a flow chart illustrating an example mode of operation for a computing device to communicate with a computing system for information retrieval over non-terrestrial networks, in accordance with techniques of this disclosure.

### DETAILED DESCRIPTION

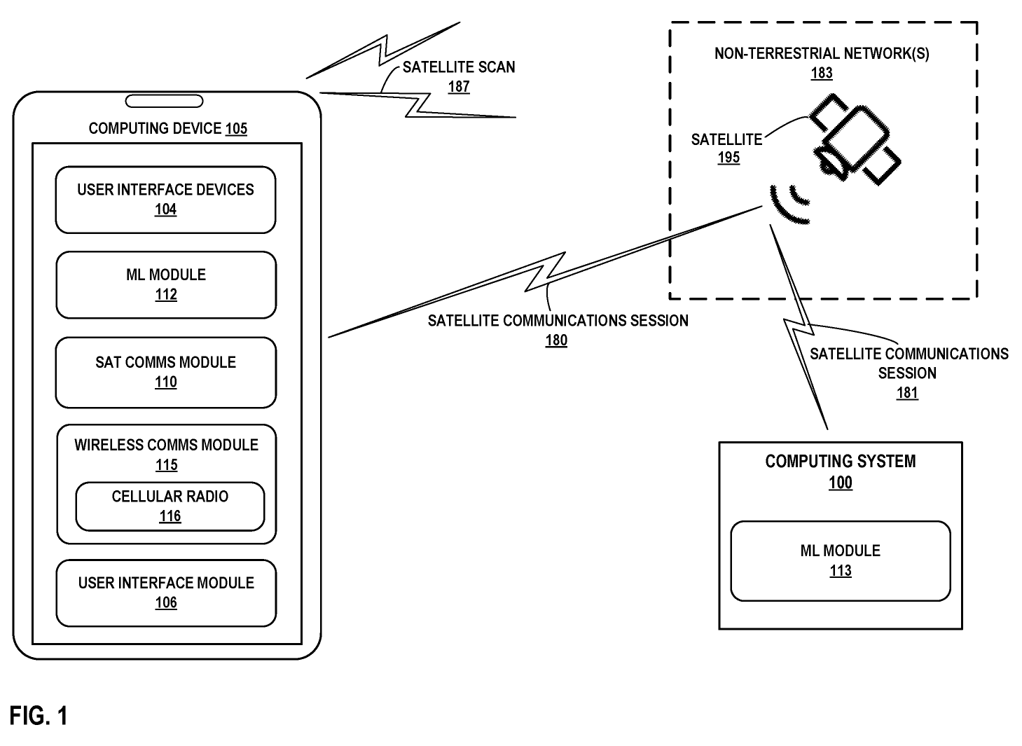

FIG. 1 illustrates an example computing device configured to use non-terrestrial networks, in accordance with one or more techniques of this disclosure. In the example of FIG. 1, computing device 105 is configured to communicate using non-terrestrial-based cellular communication systems, such as non-terrestrial network(s) 183, which may include satellite communications constellation(s) and/or satellite communications network(s). Although not shown in the example of FIG. 1, computing device 105 may be configured to communicate using terrestrial based cellular communication systems, such as wireless communications network(s). In some examples, each non-terrestrial network 183 includes one or more satellite(s) 195 which facilitate cellular communications by computing device 105. In some examples, a wireless communications network may include one or more ground-based cellular communication towers to facilitate cellular communications by computing device 105. In some examples, a wireless communications network may be or include one or more of a WI-FI network and a cellular communications network. In the example of FIG. 1, computing device 105 may communicate via cellular communications with non-terrestrial network 183 and/or a wireless communications network.

Computing device 105 may sometimes be referred herein to as a “mobile computing device,” a “mobile device,” a “mobile user device,” or a “user device.” Examples of computing device 105 may include, but are not limited to, user computing devices such as laptops, desktops, mobile computing devices (such as tablets, smartphones, wearable computing devices (e.g., “smart” or artificial intelligence glasses, smartwatches, smart rings or jewelry, smart clothing, smart headphones, virtual reality (VR) headsets, augmented reality (AR) headsets, health monitors, etc.)), a foldable computing device, a tablet computing device, an ambient computing device (including a so-called “smart display”), embedded computing devices (e.g., devices embedded within a vehicle, camera, image sensor, industrial machine, satellite, gaming console or controller, or home appliance such as a refrigerator, thermostat, energy meter, home energy manager, smart home assistant, etc.), other computing devices, or combinations thereof. Computing device 105 that implements aspects of the present disclosure may include a number of hardware components that enable the performance of the techniques described herein.

In the example of FIG. 1, computing device 105 includes wireless communications module 115 having cellular radio 116 via which to communicate with non-terrestrial network 183 and/or wireless communications network(s) using cellular communications. Cellular radio 116 is sometimes referred to as a cellular transceiver or a cellular transmitter/receiver. In the example of FIG. 1, computing device 105 includes one or more wireless communication modules, such as satellite communication module 110 and wireless communications module 115. In some examples, satellite communication module 110 has direct access to cellular radio 116 via a communications bus of computing device 105. For instance, satellite communication module 110 may indirectly access cellular radio 116 for use with cellular communications over satellite through an operating system of computing device 105. In other examples, satellite communication module 110 indirectly accesses cellular radio 116 for use with satellite communications through wireless communications module 115 of computing device 105. In general, while the techniques described herein may be associated with non-terrestrial network connections, in some examples, the techniques described herein may be applied to metered terrestrial connections, throttled connections, other scenarios with limited bandwidth or high latency, such as congested cellular networks or poor Wi-Fi connections, etc.

In general, computing device 105 may perform satellite scan 187 (e.g., via a modem of computing device 105) to discover one or more authorized and accessible non-terrestrial networks. In the example of FIG. 1, non-terrestrial network(s) 183 may be or include one or more “authorized” and “accessible” non-terrestrial networks. In some examples, a particular non-terrestrial network may be authorized if computing device 105 is permitted by law to connect to the particular non-terrestrial network based on a geographic location of computing device 105 (i.e., whether computing device 105 is located in a geographic location that legally permits computing device 105 to connect to the particular non-terrestrial network). A particular non-terrestrial network may be accessible if computing device 105 is located within an accessibility range of the particular non-terrestrial network.

Computing device 105 may include one or more user interface devices (“UID”) 104. UID 104 of computing device 105 may be configured to function as input devices and/or output devices for computing device 105. UID 104 may be implemented using various technologies. For instance, UID 104 may be configured to receive input from a user through tactile, audio, and/or video feedback. Examples of input devices include a presence-sensitive display, a presence-sensitive or touch-sensitive input device (such as that shown in FIG. 1), a mouse, a keyboard, a voice responsive system, video camera, microphone or any other type of device for detecting a command from a user. In some examples, a presence-sensitive display includes a touch-sensitive or presence-sensitive input screen, such as a resistive touchscreen, a surface acoustic wave touchscreen, a capacitive touchscreen, a projective capacitive touchscreen, a pressure sensitive screen, an acoustic pulse recognition touch screen, or another presence-sensitive technology. That is, UID 104 of computing device 105 may include a presence-sensitive device that may receive tactile input from a user. In general, UID 104 may detect gestures as input from a user. UID 104 may receive indications of the tactile input by detecting one or more gestures from a user (e.g., when a user touches or points to one or more locations of UID 104 with a finger or a stylus pen).

UID 104 may additionally or alternatively be configured to function as an output device by providing output to a user using tactile, audio, or video stimuli. Examples of output devices include a sound card, a video graphics adapter card, or any of one or more display devices, such as a liquid crystal display (LCD), dot matrix display, light emitting diode (LED) display, microLED, miniLED, organic light-emitting diode (OLED) display, e-ink, or similar monochrome or color display capable of outputting visible information to a user. Additional examples of an output device include a speaker, a haptic device, or other device that can generate intelligible output to a user. UID 104 may present the output as a graphical user interface (GUI), which may be associated with functionality provided by computing device 105. For example, UID 104 may present various user interfaces (e.g., GUIs associated with a lock screen GUIs, home screen GUIs, software application GUIs, camera input GUIs, input text box GUIs, input audio GUIs, etc.) of components of a computing platform, operating system, applications, or services executing at or accessible by computing device 105. A user may interact with a respective user interface to cause computing device 105 to perform operations relating to a function.

In some examples, UID 104 of computing device 105 may detect two-dimensional and/or three-dimensional gestures as input from a user. For instance, a sensor of UID 104 may detect the user's movement (e.g., moving a hand, an arm, a pen, a stylus, etc.) within a threshold distance of the sensor of UID 104. UID 104 may determine a two- or three-dimensional vector representation of the movement and correlate the vector representation to a gesture input (e.g., a hand-wave, a pinch, a clap, a pen stroke, etc.) that has multiple dimensions. In other words, UID 104 may, in some examples, detect a multidimensional gesture without requiring the user to gesture at or near a screen or surface at which UID 104 outputs information for display. Instead, UID 104 may detect a multi-dimensional gesture performed at or near a sensor which may or may not be located near the screen or surface at which UID 104 outputs information for display.

In the example of FIG. 1, computing device 105 includes user interface (UI) module 106. UI module 106 may perform operations described herein using hardware, software, firmware, or a mixture thereof residing in and/or executing at computing device 105. Computing device 105 may execute module 106 with one processor or with multiple processors. In some examples, computing device 105 may execute module 106 as a virtual machine executing on underlying hardware. Module 106 may execute as one or more services of an operating system or computing platform or may execute as one or more executable programs at an application layer of a computing platform. UI module 106, as shown in the example of FIG. 1, may be operable by computing device 105 to perform one or more functions, such as receive input and send indications of such input to other components associated with computing device 105. UI module 106 may also receive data from components associated with computing device 105. Using the data received, UI module 106 may cause other components associated with computing device 105, such as UID 104, to provide output based on the data.

In general, UI module 106 may process user interactions with UID 104 and other components of computing device 105. UI module 106 may act as an intermediary between various components of computing device 105 to make determinations based on indications of user inputs detected by UID 104 and generate output at UID 104 in response to the user inputs. UI module 106 may receive instructions from an application, service, platform, or other module of computing device 105 and/or computing device 105 to cause UID 104 to output GUIs. In some examples, GUIs may display data according to instructions stored at an operating system of computing device 105, a software application of computing device 105, or the like.

Computing system 100 may represent any suitable remote computing system, such as one or more desktop computers, laptop computers, mainframes, servers, cloud computing systems, etc. capable of sending and receiving information both to and from computing device 105. In some examples, computing system 100 may represent a cloud computing system that provides one or more services, e.g., machine learning services, via a network, e.g., any public or private communication network, such as a cellular network, Wi-Fi network, a direct cell-to-satellite communication network, or other type of network for transmitting data between computing device 105 and computing device 105, such as at least one accessible non-terrestrial network from non-terrestrial networks 183. In some examples, computing system 100 may be a distributed computing system. One or more computing devices, such as computing device 105, may access the services provided by computing system 100 by communicating with computing system 100.

Computing device 105 and computing system 100 may be in communication with each other via at least one accessible non-terrestrial network from non-terrestrial networks 183. In the example of FIG. 1, computing device 105 may be connected, e.g., may establish communications session 180 with at least one non-terrestrial network 183 including satellite(s) 195. Computing system 100 may be connected, e.g., may establish communications session 181 with at least one non-terrestrial network 183 including satellite(s) 195. As such, the at least one non-terrestrial network 183 including satellite(s) 195 may facilitate communications between computing device 105 and computing system 100.

Computing device 105 may transmit data to satellite 195 via satellite communications session 180 (e.g., using satellite communications module 110, which may include a satellite communications modem), and computing system 100 may transmit data to satellite 195 via satellite communications session 181. Satellite communications session 180 may be a device-to-satellite link or uplink with satellite 195, and satellite communications session 181 may be a server-to-satellite (or ground station) link or downlink with satellite 195. That is, in general, satellite 195 may act as an intermediary between computing device 105 and computing system 100. In some examples, satellite communications session 180 and satellite communications session 181 may each be included in a communications session between computing device 105 and computing system 100.

Computing system 100 may be a ground-based computing system or a non-terrestrial-based computing system. Computing system 100 may be or include one or more ground-based servers. In some examples, computing system 100 may include a satellite terminal and establish a direct satellite communications session 181 with satellite 195. In some examples, satellite 195 may send data to a ground station (e.g., an Earth-based gateway) (not shown in FIG. 1), in which the ground station may then route the data to computing system 100 via a terrestrial network (fiber, internet, etc.). In some examples, satellite 195 may forward data to another satellite (not shown in FIG. 1) that connects to computing system 100 and/or a ground station. In some examples, satellite 195 may include a computing system, e.g., computing system 100 or one or more other servers. In some examples, satellite 195 may include or provide the functionality of computing system 100. As such, in some examples, computing device 105 may receive responses from one or more servers included in satellite 195, which may reduce latency, as data may not have to be further transmitted to a ground station or ground-based server (e.g., computing system 100) to receive responses. In some examples, computing system 100 and/or one or more servers included in satellite 195 may be updated periodically from the ground. In some examples, e.g., examples in which satellite 195 includes one or more servers, if the one or more servers included in satellite 195 cannot handle a user query and/or provide a response, the one or more servers included in satellite 195 may query a ground-based server, such as computing system 100.

In general, a user may be provided with an opportunity to provide input to control whether programs or features of computing device 105 and/or computing system 100 can collect and make use of user information (e.g., a user’s personal data, information about a user’s current location, location history, activity, etc.), or to dictate whether and/or how computing device 105 and/or computing system 100 may receive content that may be relevant to a user. Other user information may include data that includes the context of user usage, either obtained from an application itself or from other sources. Examples of usage context may include breadth of share (sharing publicly, or with a large group, or privately, or a specific person), context of share, etc. When permitted by the user, additional data can include the state of the device, e.g., the location of the device, the apps running on the device, etc. In addition, certain data may be treated in one or more ways before it is stored or used by computing device 105 and/or computing system 100 so that personally identifiable information is removed. For example, a user’s identity may be treated so that no personally identifiable information can be determined about the user, or a user’s geographic location may be generalized where location information is obtained (such as to a city, ZIP code, or state level), so that a particular location of a user cannot be determined. Additional anonymization techniques may be used. For example, user data may be aggregated, pseudonymized using temporary identifiers, and/or have personally identifiable elements removed or generalized (e.g., replacing precise location data with broader region indicators). Furthermore, in general, computing device 105 and/or computing system 100 may only collect and retain only a minimum amount of user data necessary to provide the techniques described herein, and any user data that is collected may be stored securely (e.g., using appropriate encryption and access control measures to protect against unauthorized access or disclosure). In general, users may be provided with clear and accessible mechanisms to review, manage, and delete their data, and to control the types of data collected and how it is used. Thus, a user may have control over how information is collected about them and used by computing device 105 and/or computing system 100. For example, a user may be prompted by computing device 105 to provide explicit consent for computing device 105 and/or computing system 100 to retrieve and/or store any or all of a user’s data. In some examples, an action log executed on computing device 105 may provide a user a ledger of activity, which may show any automations or applications running in the background of computing device 105, as well as an accurate log of all computing system 100 activity.

In some examples, UID 104 may include one or more antennas. UI module 106 may cause UID 104 to output a satellite pointing UI to facilitate connecting computing device 105 with non-terrestrial network 183 using satellite based cellular communications. In such examples, the satellite pointing UI may output instructions to a display of computing device 105 indicating how to move and/or re-orient computing device 105 to align the one or more antennas with satellite 195, such that computing device 105 may be successfully connected with satellite 195 to establish satellite communications session 180.

In some examples, that computing device 105 may only connect with non-terrestrial network 183 based on computing device 105 being geographically located in a geographic location authorized for connecting to non-terrestrial networks 183, a memory of computing device 105 may be updated to include a current geographic location of computing device 105. Furthermore, in some examples, a particular non-terrestrial network may be accessible if computing device 105 is located within an accessibility range of the particular non-terrestrial network. In some examples, a particular non-terrestrial network may be accessible based on the results of satellite scan 187. In some examples, additionally or alternatively, a particular non-terrestrial network may be accessible based on an established satellite communications session 180 maintaining a satellite signal strength above a threshold. As such, the non-terrestrial networks that are accessible to computing device 105 and are authorized to establish satellite communications session 180 with computing device 105 may change as computing device 105 moves across geographic regions. In some examples, computing device 105 may only send and receive messages and/or exchange information utilizing non-terrestrial networks 183 when satellite communications session 180 is successfully established. In some examples, computing device 105 may exchange messages with one or more other devices over satellite communications session 180.

While computing device 105 is in satellite communications session 180, computing device 105 may receive data indicative of at least one user input. That is, a user operating computing device 105 may provide a query to computing device 105. In some examples, computing device 105 may include one or more applications. In some examples, computing device 105 may include ML module 112, which may perform one or more machine learning techniques on computing device 105. In some examples, ML module 112 may be or include a machine learning application, e.g., an “artificial intelligence (AI) agent” or “chatbot,” which a user may execute for various purposes, such as information retrieval. That is, in general, ML module 112 may be or include at least one on-device machine learning model, such as a language model, that is pre-trained on large and diverse sets of data (e.g., publicly available text data, code repositories, image data, audio data, video data, multimodal data, etc.). In general, computing device 105 may include an amount of RAM to perform some on-device machine learning tasks using ML module 112. That is, while computing device 105 may be equipped with ML module 112 to generate responses based on pre-trained knowledge, user-provided queries, and local computing device 105 data, in some examples, computing device 105 may not be equipped with an amount of RAM, power, etc. required to perform more advanced machine learning techniques, such as those performed by ML module 113 of computing system 100. For example, in some examples, ML module 112 may not be configured to perform more advanced machine learning techniques, such as those that require a significant amount of RAM and/or computing power. Conversely, computing system 100, which may be or include one or more cloud-based servers, includes ML module 113, which may be or include larger cloud-based models that can retrieve web-based information through techniques such as retrieval-augmented generation (RAG). Although ML module 112 may be a lightweight, e.g., less computationally expensive, on-device model in general, in some other examples, ML module 112 may be or include one or more machine learning models included in ML module 113, e.g., models that can retrieve web-based information through techniques such as retrieval-augmented generation (RAG). However, in general, while computing device 105 is in satellite communication, ML module 112 may be an on-device machine learning model. In some examples, ML module 112 may be an on-device machine learning model operating in a low power mode, and/or may be operating in a mode in which the capabilities of ML module 112 are reduced. For example, a “low power mode” may be a mode in which computing device 105 does not have Internet connection, and thus ML module 112 cannot retrieve web-based information through more advanced machine learning techniques.

As such, in accordance with the techniques of this disclosure, computing device 105 may be configured to transmit user queries to computing system 100 via satellite 195, in which computing system 100 may apply ML module 113 to generate responses for the user queries. In some examples, ML module 113 of computing system 100 may be a server-side AI-based chatbot or other information retrieval application that can perform query processing, summarization, context management, and/or other operations that computing device 105 is unable to perform while connected to a non-terrestrial network (e.g., while using satellite communication).

As one example, a user may provide a natural language audio input such as, “Tell me about the capital of France and its population.” Computing device 105 may determine whether an amount of the data exceeds a maximum amount of data that can be transmitted via satellite communications session 180 within a predetermined time frame (e.g., whether the query would require a bandwidth that exceeds the bandwidth of satellite communications session 180 and/or non-terrestrial network 183). In some examples, additionally or alternatively, the computing device may determine whether an amount of the data exceeds data size limitations imposed by the available bandwidth of the non-terrestrial network connection. In some examples, additionally or alternatively, the computing device may determine whether one or more user queries exceeds a quota allocated to a user, e.g., a data quota for a particular session, a data quota for a predetermined time duration, etc. In the example of FIG. 1, computing device 105 may determine whether satellite communications session 180 has enough available bandwidth to transmit the user query, e.g., a natural language input, to computing system 100, in which computing system 100 can process, analyze, and provide output based on the natural language input. For instance, computing system 100 may include ML module 113, which may be or include a large language model capable of processing the natural language input.

However, provided that bandwidth for satellite connections may be limited, computing device 105 may determine that the data indicative of the user input needs to be modified (e.g., reduced, compressed, summarized, etc.) prior to transmitting the input to computing system 100. As such, responsive to determining the amount of the data exceeds a maximum amount of data, computing device 105 may apply one or more transformations to the data to reduce the amount of the data. A “transformation,” as used herein, may refer to any process that modifies the data indicative of a user input and/or a generated response to reduce its size, change its format, or extract relevant features, while preserving sufficient information content for the remote computing system to generate a meaningful response. In some examples, computing device 105 may apply ML module 112 to the data indicative of the user input to generate modified data. For example, the transformations may include one or more of feature selection, data compression, data summarization, redundant data removal, approximate data processing, encoding, tokenization, data caching, data merging, etc. Responsive to determining an amount of the modified data does not exceed the maximum amount of data, computing device 105 may transmit, to computing system 100 and via satellite communications session 180, the modified data. More specifically, computing device 105 may transmit the modified data to satellite 195 via satellite communications session 180, in which satellite 195 may transmit the modified data to computing system 100 via satellite communications session 181.

In some examples, computing device 105 may also transmit a prompt, in which the prompt is indicative of context information for computing device 105 (e.g., information associated with a location of computing device 105, an indication of satellite communications session 180 with non-terrestrial network 183, an indication of one or more wireless communications networks being outside of an accessibility range of computing device 105 for an amount of time, an indication of a cellular signal strength of computing device 105 being below a threshold for an amount of time, etc.). In some examples, the prompt may include information indicative of the maximum amount of data that can be transmitted via the non-terrestrial network connection within a predetermined time frame, data size limitations imposed by the available bandwidth of the non-terrestrial network connection, a quota allocated to a user (e.g., a data quota for a particular session, a data quota for a predetermined time duration, etc.), and the like. Thus, in general, based on the modified data and the prompt, computing system 100 may generate responses (e.g., text outputs) that do not exceed bandwidth limitations or other limitations for the non-terrestrial network connection that computing device 105 has established. In some examples, computing system 100 may determine that the data indicative of a generated response (e.g., at least one text output) needs to be modified (e.g., reduced, compressed, summarized, etc.) prior to transmitting the data indicative of the response to computing device 105. As such, in some examples, computing system 100 may apply one or more transformations to the data indicative of the response to reduce the amount of the data. Computing system 100 may transmit, to computing device 105, the modified data indicative of the at least one text output.

Computing device 105 may receive, from computing system 100 and via the satellite connection, the data indicative of the response, e.g., at least one text output, generated by computing system 100. Computing device 105 may generate, for display by a user interface device (e.g., a device home screen), the response, e.g., the at least one text output. For example, continuing the example above, based on a natural language audio input such as, “Tell me about the capital of France and its population,” the at least one text output generated by computing system 100 may be a first text output such as, “Paris is the capital of France. Its population is about 2.1 million.”

In this way, the techniques described herein may improve and/or increase the functionality of computing devices operating in remote areas with limited connectivity. Typically, computing devices operating in remote areas with limited connectivity may not be able to provide services such as web-based information retrieval, which may be needed to fulfill various user requests (e.g., for navigation), as many web search engines and online services may time out if the response is too slow (e.g., due to the high latency of satellite connections). Furthermore, some non-terrestrial network (e.g., satellite communications network) providers may block access to certain search engines due to government regulations, corporate policies, etc., and/or may limit the amount of data that a user can access while using a non-terrestrial network. As such, by modifying and/or optimizing user queries and/or responses to align with the allotted bandwidth of connections to non-terrestrial networks, the techniques described herein may reduce response time and provide enhanced access to information and services for users located in remote areas, which may improve overall user experience with computing devices operating in remote areas. Furthermore, in examples in which a satellite includes one or more servers for performing web-based information retrieval, latency of the satellite connection may be decreased. Lastly, the techniques described herein may provide solutions for enabling more computationally powerful machine learning models, such as large language models, for information retrieval over non-terrestrial networks with limited bandwidth where such large language models may not otherwise be available. That is, by using on-device methods to modify and/or optimize user queries, and by using context information to optimize responses (e.g., responses generated by large language models hosted on one or more servers), techniques of this disclosure provide users access to more advanced machine learning capabilities while connected to non-terrestrial connections where such functionality would not have been feasible. In other words, the techniques described herein may provide solutions for integrating an AI-based chatbot or other information retrieval application with satellite communication infrastructure to provide a low-bandwidth, text-based interface for information retrieval and basic services.

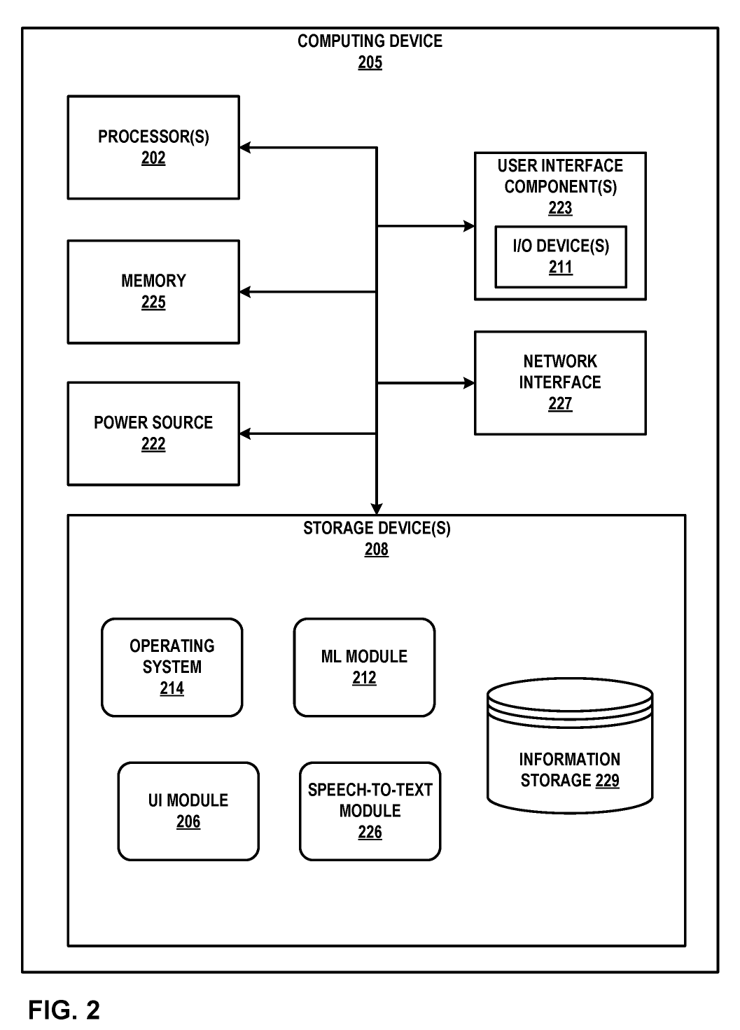

FIG. 2 is a block diagram illustrating another example computing device configured to use non-terrestrial networks, in accordance with one or more techniques of this disclosure. FIG. 2 illustrates only one particular example of computing device 205, which may be similar if not substantially similar to computing device 105 of FIG. 1. Many other example embodiments of computing device 205 may be used in other instances.

As shown in the specific example of FIG. 2, computing device 205 may include one or more processors 202, memory 225, network interface 227, one or more storage devices 208, user interface components 223, and power source 222. Computing device 205 may also include operating system 214, UI module 206 (which may be similar if not substantially similar to UI module 106 of FIG. 1), ML module 212 (which may be similar if not substantially similar to ML module 112 of FIG. 1), speech-to-text module 226, and information storage 229. Computing device 205 may include one or more other applications, modules, components, etc. not shown in the example of FIG. 2 that may also be executable by computing device 205. Components of computing device 205 may be interconnected (physically, communicatively, and/or operatively) for inter-component communications. Any applications or modules implemented within or executed by computing device 205 may be implemented or contained within, operable by, executed by, and/or be operatively/communicatively coupled to components of computing device 205, e.g., one or more processors 202, memory 225, network interface 227, one or more storage devices 208, and user interface components 223.

In some examples, processing circuitry including one or more processors 202 implements functionality and/or processes instructions for execution within computing device 205. For example, one or more processors 202 may be capable of processing instructions stored in memory 225 and/or instructions stored on one or more storage devices 208.

Memory 225, in one example, may store information within computing device 205 during operation. Memory 225, in some examples, may represent a computer-readable storage medium. In some examples, memory 225 may be a temporary memory, meaning that a primary purpose of memory 225 may not be long-term storage. Memory 225, in some examples, may be described as a volatile memory, meaning that memory 225 may not maintain stored contents when computing device 205 is turned off. Examples of volatile memories may include random access memories (RAM), dynamic random-access memories (DRAM), static random-access memories (SRAM), and other forms of volatile memories. In some examples, memory 225 may be used to store program instructions for execution by one or more processors 202. Memory 225, in one example, may be used by software or applications running on computing device 205 to temporarily store data and/or instructions during program execution.

One or more storage devices 208, in some examples, may also include one or more computer-readable storage media. One or more storage devices 208 may be configured to store larger amounts of information than memory 225. One or more storage devices 208 may further be configured for long-term storage of information. In some examples, one or more storage devices 208 may include non-volatile storage elements. Examples of such non-volatile storage elements may include magnetic hard disks, optical discs, floppy disks, Flash memories, or forms of electrically programmable memories (EPROM) or electrically erasable and programmable (EEPROM) memories.

Computing device 205, in some examples, may also include network interface 227. Computing device 205, in such examples, may use network interface 227 to communicate with external devices via one or more networks, such as one or more wired or wireless networks. Network interface 227 may be a network interface card, such as an Ethernet card, an optical transceiver, a radio frequency transceiver, a cellular transceiver or cellular radio, or any other type of device that can send and receive information. Other examples of such network interfaces may include BLUETOOTH®, 3G, 4G, 2G, LTE, and WI-FI® radios in mobile computing devices as well as USB. In some examples, computing device 205 may use network interface 227 to wirelessly communicate with an external device such as a server, mobile phone, or other networked computing device.

Computing device 205, in some examples, may include power source 222, which may be rechargeable and provide power to computing device 205. Power source 222, in some examples, may be a battery made from nickel-cadmium, lithium-ion, or other suitable material.

Examples of computing device 205 may include operating system 214. Operating system 214 may be stored in one or more storage devices 208 and may control the operation of components of computing device 205. For example, operating system 214 may facilitate the interaction of one or more applications or modules with hardware components of computing device 205. In some examples, operating system 214 may be configured to scan, via processing circuitry of computing device 205, for available satellite networks, wireless networks (e.g., WI-FI networks and cellular networks), or other types of networks.

As shown in the example of FIG. 2, computing device 205 includes one or more user interface (UI) components (“UI components 223”). UI components 223 may be implemented using various technologies. UI components 223 of computing device 205 may be configured to function as one or more input/output (I/O) devices 211 for computing device 205. One or more I/O devices 211 of computing device 205 may receive inputs and generate outputs. Examples of inputs are tactile, audio, video, kinetic, and optical input, to name only a few examples. Input devices of I/O devices 211, in some examples, may include a presence-sensitive display, a presence-sensitive or touch-sensitive input device, a mouse, a keyboard, a voice responsive system, video camera, microphone or any other type of device for detecting input from a human or machine. In some examples, a presence-sensitive display includes a touch-sensitive or presence-sensitive input screen, such as a resistive touchscreen, a surface acoustic wave touchscreen, a capacitive touchscreen, a projective capacitive touchscreen, a pressure sensitive screen, an acoustic pulse recognition touch screen, or another presence-sensitive technology. That is, UI components 223 of computing device 205 may include a presence-sensitive device that may receive tactile input from a user. UI components 223 may receive indications of the tactile input by detecting one or more gestures from a user (e.g., when a user touches or points to one or more locations of UI components 223 with a finger or a stylus pen).

In some examples, UI components 223 of computing device 205 may detect two-dimensional and/or three-dimensional gestures as input from a user. For instance, a sensor of UI components 223 may detect the user's movement (e.g., moving a hand, an arm, a pen, a stylus, etc.) within a threshold distance of the sensor of UI components 223. UI components 223 may determine a two- or three-dimensional vector representation of the movement and correlate the vector representation to a gesture input (e.g., a hand-wave, a pinch, a clap, a pen stroke, etc.) that has multiple dimensions. In other words, UI components 223 may, in some examples, detect a multidimensional gesture without requiring the user to gesture at or near a screen or surface at which UI components 223 output information for display. Instead, UI components 223 may detect a multi-dimensional gesture performed at or near a sensor which may or may not be located near the screen or surface at which UI components 223 output information for display. In some examples, UI components 223 may detect information that indicates a user’s movement speed, etc. across a geographic region.

Output devices of I/O devices 211, in some examples, may include a sound card, a video graphics adapter card, or any of one or more display devices, such as a liquid crystal display (LCD), dot matrix display, light emitting diode (LED) display, microLED, miniLED, organic light-emitting diode (OLED) display, e-ink, or similar monochrome or color display capable of outputting visible information to a user. Additional examples of an output device include a speaker, a haptic device, or other device that can generate intelligible output to a user.

In some examples, UI components 223 may present output to a user as a graphical user interface that may be associated with functionality provided by computing device 205. In this way, UI components 223 may present various user interfaces of applications executing at or accessible by computing device 205 (e.g., an electronic message application, an Internet browser application, etc.). A user may interact with a respective user interface of an application to cause computing device 205 to perform operations relating to a function provided by the application. In some examples, one or more applications executing at or accessible by computing device 205 may query computing device 205 location. In these examples, computing device 205 may register a listener with a location service for such location querying events. In some examples, the location querying events may only be processed by computing device 205 when computing device 205 has traversed a threshold distance (e.g., 50 miles).

In general, input may be received by UI module 206 in response to one or more gestures being detected via I/O devices 211 (such as UID 104 of FIG. 1). That is, UI module 206 may receive inputs detected and/or provided at an input device (e.g., one or more indications of one or more gestures detected at an input device, natural language inputs, image inputs, etc.), and may relay information about the inputs to one or more associated platforms, operating systems, applications, and/or services executing at computing device 205 and/or a computing system in communication with computing device 205 (e.g., computing system 100 of FIG. 1) to cause computing device 205 and/or computing system 100 to perform a function. As an example, UI module 206 may output, for display at a display device, a GUI including text output generated by computing system 100 and received by computing device 205.

In general, UI module 206 may interpret received inputs, e.g., UI module 206 may determine types of inputs and/or whether a user should repeat or clarify inputs. UI module 206 may also receive information and instructions from one or more associated platforms, operating systems, applications, and/or services (e.g., computing system 100 of FIG. 1) for generating a file comprising a set of instructions. In general, the set of instructions may provide data for generating one or outputs for display at a display device. In some examples, UI module 206 may act as an intermediary between the one or more associated platforms, operating systems, applications, and/or services and various output devices (e.g., speakers, LED indicators, vibrators, etc.) to produce output (e.g., graphical, audible, tactile, etc.).

In general, computing system 205 may receive indications of user input. For example, the user input may include a natural language user input, which may be an audio or text input from a user. In examples where the user input is an audio input (e.g., comprising spoken language), speech-to-text module 226 may convert the input into a computer-readable format. Speech-to-text module 226 may implement an Automatic Speech Recognition (ASR) system to convert an audio input (e.g., a digital audio signal) into written text. In some examples, speech-to-text module 226 may preprocess the audio input to enhance quality and remove noise by normalizing the audio volume and filtering out any background noise. Speech-to-text module 226 may then transform the audio input into a more suitable format and extract features such as Mel-frequency cepstral coefficients (MFCCs), which capture information about the frequency content of the audio signal over short time intervals. In some examples, speech-to-text module 226 may perform acoustic modeling (e.g., with Hidden Markov Models (HMMs)), which may involve training a statistical model that maps the extracted audio features to phonemes. The acoustic model may learn to associate specific audio features with phonemes while taking into account the variations in pronunciation, accents, and speaking styles. In some examples, speech-to-text module 226 may further implement language modeling (e.g., deep learning techniques, such as recurrent neural networks (RNNs) and transformers) to capture and predict a sequence of words or phrases while considering the context in which the words are spoken (e.g., speech-to-text module 226 may use context information received by UI module 206). Speech-to-text module 226 may further use the trained acoustic and language models to decode the audio input and generate a transcription or sequence of words that best match the observed audio features. Speech-to-text module 226 may further implement post-processing techniques (e.g., grammar checks, contextual analysis, spell correction, etc.) to refine the transcription and improve readability and accuracy. Speech-to-text module 226 may then output the transcribed text that represents the audio input to ML module 212 for further processing and analysis.

As shown in FIG. 2, ML module 212 may be stored in one or more storage devices 208 along with information storage 229. In general, information storage 229 may store context information for computing device 205, and/or for a communication session between computing device 205 and a user operating computing device 205. The context information for computing device 205 may include one or more of information associated with a location of computing device 205, an indication of the connection with the at least one accessible non-terrestrial network, an indication of one or more wireless communications networks being outside of an accessibility range of computing device 205 for an amount of time, and an indication of a cellular signal strength of computing device 205 being below a threshold for an amount of time. Furthermore, in some examples, information storage 229 may store information pertaining to a communication session with a user, such as a session identifier. That is, when a user provides a first input, computing device 205 may store, at least temporarily, the data indicative of the first user input in information storage 229 with a unique session identifier. Then, if the user provides additional inputs, computing device 205 may store, at least temporarily, the data indicative of the additional user inputs in information storage 229 with the unique session identifier, provided that the additional user inputs are part of the same session, e.g., conversation. In some examples, ML module 212 may determine when a session ends and a new session begins, e.g., based on a change in conversation topic, explicit user instruction, a time basis, etc.

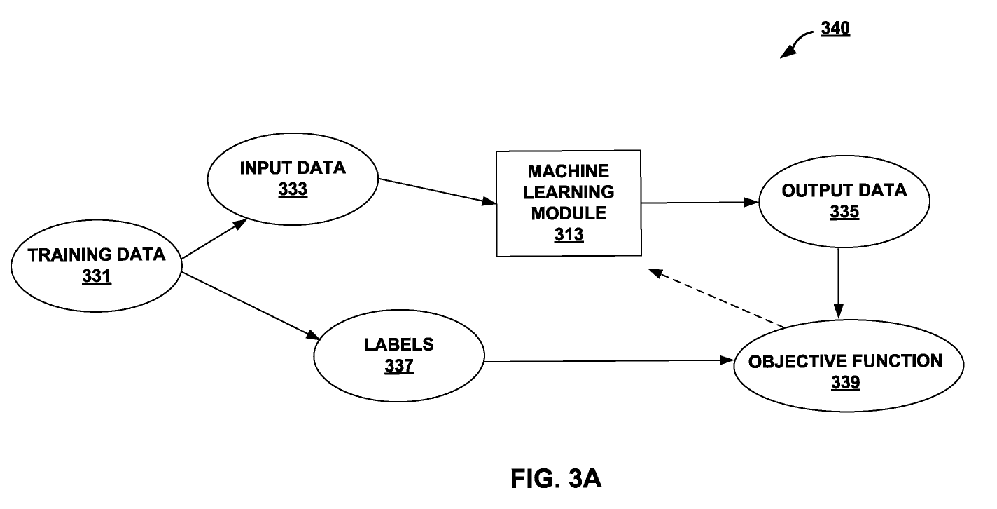

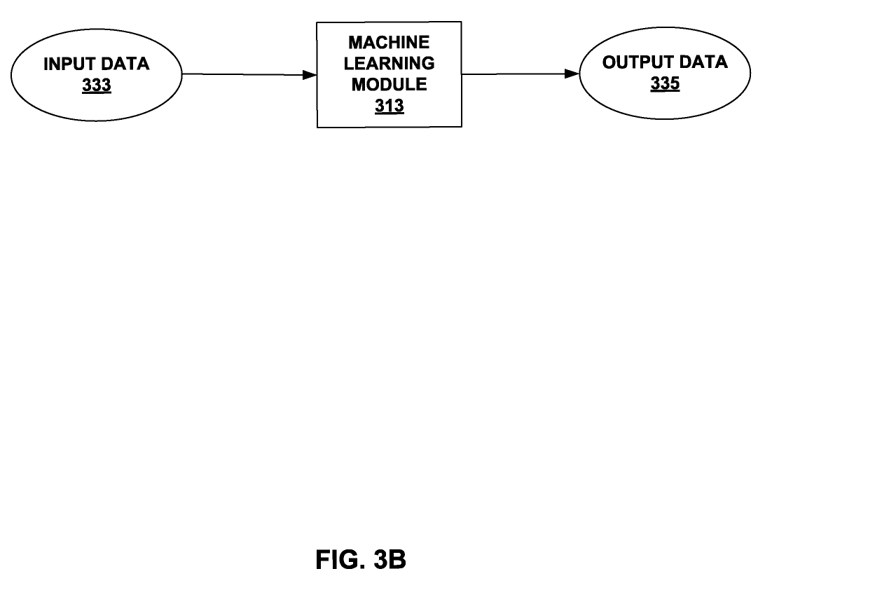

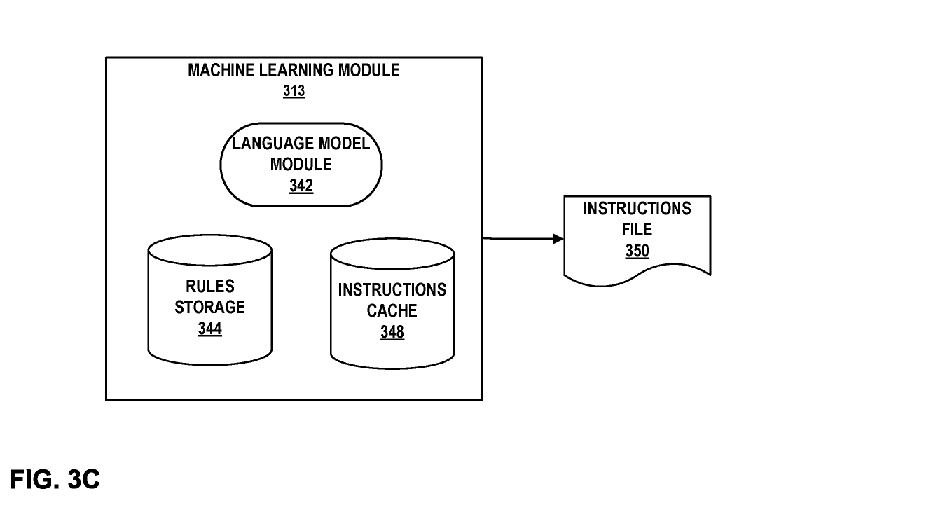

In general, machine learning module 212 may be configured to interpret various types of input received by UI module 206 and information stored in information storage 229. In some examples, machine learning module 212 may be configured to infer any indication of a natural language user input. In other words, machine learning module 212 may infer capabilities from user intents. In some examples, machine learning module 212 may search capabilities. In some examples, machine learning module 212 may convert the audio or text input received by UI module 206 and/or the transcribed text output from speech-to-text module 226 into structured text. For example, machine learning module 212 may convert any input or information to an eXtensible Markup Language (XML), or other structured text types, such as, but not limited to, HTML, JSON, CSV, INI Files, etc. In this way, information may be transmitted to other computing devices, systems, and/or platforms (such as computing system 100 of FIG. 1) in a standardized format. In some examples, input and/or information received by computing device 205 may be preprocessed. Preprocessing techniques may include extracting one or more additional features from raw data. For example, feature extraction techniques may be applied to the user input or retrieved instructions to generate one or more new, additional features. In some examples, machine learning module 212 may implement various machine learning techniques, such as one or more of those described with respect to FIGS. 3A, 3B and 3C. In some examples, machine learning module 212 may analyze portions of information to interpret and understand other portions of information. Machine learning module 212 may analyze information (e.g., user input) to interpret and understand other user input.

FIG. 3A is a conceptual diagram illustrating an example training process for a machine learning module, in accordance with one or more techniques of this disclosure. In some examples, computing device 105 of FIG. 1 may store and implement machine learning module 313 locally (i.e., on-device). Thus, in some examples, machine learning module 313 can be stored at and/or implemented locally by an embedded device or a user computing device such as a mobile device. In some examples, computing device 105 of FIG. 1 may include machine learning module 313 rather than machine learning module 112. Output data obtained through local implementation of machine learning module 313 at the embedded device or the user computing device can be used to improve performance of the embedded device or the user computing device (e.g., an application implemented by the embedded device or the user computing device). Machine learning module 313 described herein can be trained at a training computing system, and then provided for storage and/or implementation at one or more computing devices, such as computing device 105 of FIG. 1. In some examples, training process 340 executes locally at computing device 105 of FIG. 1. However, in some examples, training process 340 can be included in or separate from any computing system that implements machine learning module 313.

In general, machine learning module 313 may be or include one or more inference models, i.e., one or more trained machine learning models that can be used to make predictions based on new, unseen data. Machine learning module 313 may “infer” conclusions or outputs, which may be predictions, classifications, recommendations, or other types of decision-making. Machine learning module 313 may be trained according to one or more of various different training types or techniques. For example, in some examples, machine learning module 313 may be trained by training process 340 of FIG. 3A.

As further shown in the example of FIG. 3A, in some examples, machine learning module 313 may be trained on training data 331 that may include input data 333 that has labels 337. The training process shown in FIG. 3A is one example training process; other training processes may be used as well. In general, during training process 340, machine learning module 313 may learn patterns from training data 331, and training process 340 may optimize parameters for machine learning module 313 to minimize prediction errors.

Training data 331 can include, upon user permission for use of such data for training, anonymized usage logs of sharing flows, e.g., content items that were shared together, bundled content pieces already identified as belonging together, e.g., from entities in a knowledge graph, etc. In some examples, training data 331 can include examples of input data 333 that have been assigned labels 337 that correspond to output data 335.

In some examples, machine learning module 313 can be trained by optimizing an objective function, such as objective function 339. For example, in some examples, objective function 339 may be or include a loss function that compares (e.g., determines a difference between) output data generated by the model from the training data and labels (e.g., ground-truth labels) associated with the training data. For example, the loss function can evaluate a sum or mean of squared differences between output data 335 and the labels. In some examples, objective function 339 may be or include a cost function that describes a cost of a certain outcome or output data. Other examples of objective function 339 can include margin-based techniques such as, for example, triplet loss or maximum-margin training.

One or more of various optimization techniques can be performed to optimize objective function 339. For example, the optimization technique(s) can minimize or maximize objective function 339. Example optimization techniques include Hessian-based techniques and gradient-based techniques, such as, for example, coordinate descent; gradient descent (e.g., stochastic gradient descent); subgradient methods; etc. Other optimization techniques include black box optimization techniques and heuristics.

In some examples, backward propagation of errors can be used in conjunction with an optimization technique (e.g., gradient based techniques) to train machine learning module 313 (e.g., when a machine-learned model is a multi-layer model such as an artificial neural network).

For example, an iterative cycle of propagation and model parameter (e.g., weights) update can be performed to train machine learning module 313. Example backpropagation techniques include truncated backpropagation through time, Levenberg- Marquardt backpropagation, etc.

In some examples, machine learning module 313 described herein can be trained using unsupervised learning techniques. Unsupervised learning can include inferring a function to describe hidden structure from unlabeled data. For example, a classification or categorization may not be included in the data. Unsupervised learning techniques can be used to produce machine-learned models capable of performing clustering, anomaly detection, learning latent variable models, or other tasks.

Machine learning module 313 can be trained using semi-supervised techniques which combine aspects of supervised learning and unsupervised learning. Machine learning module 313 can be trained or otherwise generated through evolutionary techniques or genetic algorithms. In some examples, machine learning module 313 described herein can be trained using reinforcement learning. In reinforcement learning, an agent (e.g., model) can take actions in an environment and learn to maximize rewards and/or minimize penalties that result from such actions. Reinforcement learning can differ from the supervised learning problem in that correct input/output pairs are not presented, nor sub-optimal actions explicitly corrected.

In some examples, one or more generalization techniques can be performed during training to improve the generalization of machine learning module 313. Generalization techniques can help reduce overfitting of machine learning module 313 to the training data. Example generalization techniques include dropout techniques; weight decay techniques; batch normalization; early stopping; subset selection; stepwise selection; etc.

In some examples, machine learning module 313 described herein can include or otherwise be impacted by a number of hyperparameters, such as, for example, learning rate, number of layers, number of nodes in each layer, number of leaves in a tree, number of clusters; etc. Hyperparameters can affect model performance. Hyperparameters can be hand selected or can be automatically selected through application of techniques such as, for example, grid search; black box optimization techniques (e.g., Bayesian optimization, random search, etc.); gradient-based optimization; etc. Example techniques and/or tools for performing automatic hyperparameter optimization include Hyperopt; Auto-WEKA; Spearmint; Metric Optimization Engine (MOE); etc.

In some examples, various techniques can be used to optimize and/or adapt the learning rate when the model is trained. Example techniques and/or tools for performing learning rate optimization or adaptation include Adagrad; Adaptive Moment Estimation (ADAM); Adadelta; RMSprop; etc.

In some examples, transfer learning techniques can be used to provide an initial model from which to begin training of machine learning module 313 described herein. In some examples, transfer learning involves reusing a model and its model parameters obtained while solving one problem and applying it to a different but related problem. Models trained on very large data sets may be retrained or fine-tuned on additional data. Often, all model designs and their parameters on a source model are copied except output layer(s). The output layers(s) are often called the head, and other layers are often called the base. The source parameters may be considered to contain the knowledge learned from the source dataset and this knowledge may also be applicable to a target dataset. Fine-tuning may include updating the head parameters with the body parameters being fixed or updated in a later step.

In some examples, machine learning module 313 may be trained in an offline fashion or an online fashion. In offline training (also known as batch learning), machine learning module 313 is trained on the entirety of a static set of training data. In online learning, machine learning module 313 is continuously trained (or re-trained) as new training data becomes available (e.g., while the model is used to perform inference).

In some examples, training process 340 may involve centralized training of machine learning module 313 (e.g., based on a centrally stored dataset). In other implementations, decentralized training techniques such as distributed training, federated learning, or the like can be used to train, update, or personalize machine learning module 313.

Machine learning module 313 described herein can be trained according to one or more of various different training types or techniques. For example, in some examples, machine learning module 313 can be trained by training process 340 using supervised learning, in which machine learning module 313 is trained on a training dataset that includes instances or examples that have labels. The labels can be manually applied by experts, generated through crowd-sourcing, or provided by other techniques (e.g., by physics-based or complex mathematical models). In some examples, if the user has provided consent, the training examples can be provided by the user computing device. In some examples, this process can be referred to as personalizing the model.

In some examples, machine learning module 313 includes a language model that may be trained (e.g., pre-trained, fine-tuned, etc.) by training process 340. For example, training process 340 may pre-train a language model on a large and diverse corpus of text. As such, in some examples, training data 331 may include a dataset that covers a wide range of topics and domains to ensure machine learning module 313 learns diverse linguistic patterns and contextual relationships. Training process 340 may train a language model to optimize objective function 339. Objective function 339 may be or include a loss function, such as cross-entropy loss, that compares (e.g., determines a difference between) output data generated by the model from training data 331 and labels 337 (e.g., ground-truth labels) associated with training data 331. For example, objective function 339 for a language model may be to correctly predict the next word in a sequence of words or correctly fill in missing words as much as possible.

In some examples, training process 340 may use techniques such low-rank adaptation (LoRA) to train or fine-tune language models (LLMs) implemented by machine learning module 313. In general, LoRA may reduce the number of trainable parameters by freezing pre-trained weights of an LLM and injecting small, trainable low-rank matrices that adapt the model for specific tasks. LoRa may be useful when a model needs to be adapted to multiple tasks with limited task-specific data. That is, training process 340 may use LoRA for task-specific fine-tuning. In some examples, training process 340 may use techniques such as retrieval-augmented generation (RAG), which is a hybrid framework that combines information retrieval with text generation. RAG may be used to fine-tune a generative model implemented by machine learning module 313 by retrieving relevant information from an external database or dataset (e.g., a large and diverse corpus of text) and using that information to generate output that is more accurate and informative. RAG may be useful for generating more factually accurate and contextually relevant summaries and responses to questions.

In some examples, training process 340 may continuously or periodically train a language model included in machine learning module 313. In some examples, training process 340 may fine-tune a language model by using feedback in the training process. For example, UI component 232 of FIG. 2 may receive a user input via a computing device that selects feedback (e.g., thumbs up, thumbs down, etc.) relating to the generated application functionality and associated GUIs that are presented to the user on computing device 105. In some examples, the feedback may indicate whether the generated application functionality and associated GUIs are accurate or inaccurate, correct or incorrect, high quality or low quality, etc. UI module 206 may receive this feedback and may transmit the feedback to machine learning module 313 (specifically to training process 340), in which training process 340 uses the feedback for training. For example, training process 340 may convert the feedback into labeled data for supervised training. Additionally, or alternatively, training process 340 may fine-tune a language model by monitoring the relationship between the performance of the language model and user feedback, and iterate the fine-tuning process as necessary (e.g., to receive more positive user feedback and less negative user feedback). In this way, the techniques of this disclosure may establish a feedback loop that continuously improves the quality of output data 335 (e.g., an instructions file) of a language model.

FIG. 3B is a conceptual diagram illustrating an example trained machine learning module, in accordance with one or more techniques of this disclosure. In some examples, computing device 105 of FIG. 1 may store and implement machine learning module 313 locally (i.e., on-device). Thus, in some examples, machine learning module 313 can be stored at and/or implemented locally by an embedded device or a user computing device such as a mobile device. Output data obtained through local implementation of machine learning module 313 at the embedded device or the user computing device can be used to improve performance of the embedded device or the user computing device (e.g., an application implemented by the embedded device or the user computing device). Machine learning module 313 of FIG. 3B may be trained at a computing system, such as computing device 105 of FIG. 1, and then provided for storage and/or implementation at one or more computing devices, such as computing device 105 of FIG. 1. In some examples, machine learning module 313 executes locally at computing device 105 of FIG. 1. In some examples, computing device 105 may perform machine learning as a service.

As illustrated in FIG. 3B, in some examples, machine learning module 313 is trained (e.g., via training process 340 of FIG. 3A) to receive input data 333, which may be of one or more types and, in response, provide output data 335, which may be of one or more types. Thus, FIG. 3B illustrates machine learning module 313 performing inference, in which machine learning module 313 may use learned patterns to make predictions or decisions on new data, e.g., input data 333. Machine learning module 313 may include one or more machine-learned models trained by training process 340 of FIG. 3A.

Input data 333 may include one or more features that are associated with an instance or an example. In some examples, the one or more features associated with the instance or example can be organized into a feature vector. In some examples, output data 335 can include one or more predictions. Predictions can also be referred to as inferences. Thus, given features associated with a particular instance, machine learning module 313 can output a prediction for such instance based on the features.

Machine learning module 313 can be or include one or more of various different types of machine-learned models. In particular, in some examples, machine learning module 313 may perform NLP tasks. Machine learning module 313 may summarize, translate, or organize input data 333. Machine learning module 313 may use recurrent neural networks (RNNs) and/or transformer models (self-attention models). Example models may include, but are not limited to, BERT, Gemini (e.g., Gemini Ultra, Gemini Pro, Gemini Flash, Gemini Nano), Android AICore, and T5. In some examples, machine learning module 313 may perform classification, summarization, name generation, regression, clustering, anomaly detection, recommendation generation, and/or other tasks.

In some examples, machine learning module 313 can perform various types of classification based on input data 333. For example, machine learning module 313 can perform binary classification or multiclass classification. In binary classification, output data 335 can include a classification of input data 333 into one of two different classes. In multiclass classification, output data 335 can include a classification of input data 333 into one (or more) of more than two classes. The classifications can be single label or multi-label. Machine learning module 313 may perform discrete categorical classification in which input data 333 is simply classified into one or more classes or categories.

In some examples, machine learning module 313 can perform classification in which machine learning module 313 provides, for each of one or more classes, a numerical value descriptive of a degree to which it is believed that input data 333 should be classified into the corresponding class. In some instances, the numerical values provided by machine learning module 313 can be referred to as “confidence scores” that are indicative of a respective confidence associated with classification of the input into the respective class. In some examples, the confidence scores can be compared to one or more thresholds to render a discrete categorical prediction. In some examples, only a certain number of classes (e.g., one) with the relatively largest confidence scores can be selected to render a discrete categorical prediction.

Machine learning module 313 may output a probabilistic classification. For example, machine learning module 313 may predict, given a sample input, a probability distribution over a set of classes. Thus, rather than outputting only the most likely class to which the sample input should belong, machine learning module 313 can output, for each class, a probability that the sample input belongs to such class. In some examples, the probability distribution over all possible classes can sum to one. In some examples, a Softmax function, or other type of function or layer can be used to squash a set of real values respectively associated with the possible classes to a set of real values in the range (0, 1) that sum to one.

In some examples, the probabilities provided by the probability distribution can be compared to one or more thresholds to render a discrete categorical prediction. In some examples, only a certain number of classes (e.g., one) with the relatively largest predicted probability can be selected to render a discrete categorical prediction.

In cases in which machine learning module 313 performs classification, machine learning module 313 may be trained using supervised learning techniques. For example, machine learning module 313 may be trained on a training dataset that includes training examples labeled as belonging (or not belonging) to one or more classes.

In some examples, machine learning module 313 can perform regression to provide output data in the form of a continuous numeric value. The continuous numeric value can correspond to any number of different metrics or numeric representations, including, for example, currency values, scores, or other numeric representations. As examples, machine learning module 313 can perform linear regression, polynomial regression, or nonlinear regression. As examples, machine learning module 313 can perform simple regression or multiple regression. As described above, in some examples, a Softmax function or other function or layer can be used to squash a set of real values respectively associated with two or more possible classes to a set of real values in the range (0, 1) that sum to one.

Machine learning module 313 may perform various types of clustering. For example, machine learning module 313 can identify one or more previously-defined clusters to which input data 333 most likely corresponds. Machine learning module 313 may identify one or more clusters within input data 333. That is, in instances in which input data 333 includes multiple objects, documents, or other entities, machine learning module 313 can sort the multiple entities included in input data 333 into a number of clusters. In some examples in which machine learning module 313 performs clustering, machine learning module 313 can be trained using unsupervised learning techniques.

Machine learning module 313 may perform anomaly detection or outlier detection. For example, machine learning module 313 can identify input data that does not conform to an expected pattern or other characteristic (e.g., as previously observed from previous input data). As examples, the anomaly detection can be used for fraud detection or system failure detection.

In some examples, machine learning module 313 can provide output data in the form of one or more recommendations. For example, machine learning module 313 can be included in a recommendation system or engine. As an example, given input data that describes previous outcomes for certain entities (e.g., a score, ranking, or rating indicative of an amount of success or enjoyment), machine learning module 313 can output a suggestion or recommendation of one or more additional entities that, based on the previous outcomes, are expected to have a desired outcome (e.g., elicit a score, ranking, or rating indicative of success or enjoyment). As one example, given input data descriptive of a context of a computing device, such as computing device 105 of FIG. 1, a recommendation system can output a suggestion or recommendation of an application that the user might enjoy or wish to download to computing device 105.

Machine learning module 313 may, in some cases, act as an agent within an environment. For example, machine learning module 313 can be trained using reinforcement learning, which will be discussed in further detail below.

In some examples, machine learning module 313 can be a parametric model while, in other implementations, machine learning module 313 can be a non-parametric model. In some examples, machine learning module 313 can be a linear model while, in other implementations, machine learning module 313 can be a non-linear model.

As described above, machine learning module 313 can be or include one or more of various different types of machine-learned models. Examples of such different types of machine-learned models are provided below for illustration. One or more of the example models described below can be used (e.g., combined) to provide output data 335 in response to input data 333. Additional models beyond the example models provided below can be used as well.

In some examples, machine learning module 313 can be or include one or more classifier models such as, for example, linear classification models; quadratic classification models; etc. Machine learning module 313 may be or include one or more regression models such as, for example, simple linear regression models; multiple linear regression models; logistic regression models; stepwise regression models; multivariate adaptive regression splines; locally estimated scatterplot smoothing models; etc.

In some examples, machine learning module 313 can be or include one or more decision tree-based models such as, for example, classification and/or regression trees; iterative dichotomiser 3 decision trees; C4.5 decision trees; chi-squared automatic interaction detection decision trees; decision stumps; conditional decision trees; etc.

Machine learning module 313 may be or include one or more kernel machines. In some examples, machine learning module 313 can be or include one or more support vector machines. Machine learning module 313 may be or include one or more instance-based learning models such as, for example, learning vector quantization models; self- organizing map models; locally weighted learning models; etc. In some examples, machine learning module 313 can be or include one or more nearest neighbor models such as, for example, k-nearest neighbor classifications models; k- nearest neighbors regression models; etc. Machine learning module 313 can be or include one or more Bayesian models such as, for example, naïve Bayes models; Gaussian naïve Bayes models; multinomial naïve Bayes models; averaged one-dependence estimators; Bayesian networks; Bayesian belief networks; hidden Markov models; etc.

In some examples, machine learning module 313 can be or include one or more artificial neural networks (also referred to simply as neural networks). A neural network can include a group of connected nodes, which also can be referred to as neurons or perceptrons. A neural network can be organized into one or more layers. Neural networks that include multiple layers can be referred to as “deep” networks. A deep network can include an input layer, an output layer, and one or more hidden layers positioned between the input layer and the output layer. The nodes of the neural network can be connected or non-fully connected.

Machine learning module 313 can be or include one or more feed forward neural networks. In feed forward networks, satellite communications session 180s between nodes do not form a cycle. For example, each connection can connect a node from an earlier layer to a node from a later layer.

In some instances, machine learning module 313 can be or include one or more recurrent neural networks. In some instances, at least some of the nodes of a recurrent neural network can form a cycle. Recurrent neural networks can be especially useful for processing input data that is sequential in nature. In particular, in some instances, a recurrent neural network can pass or retain information from a previous portion of input data 333 sequence to a subsequent portion of input data 333 sequence through the use of recurrent or directed cyclical node connections.

In some examples, sequential input data can include time-series data (e.g., sensor data versus time or imagery captured at different times). For example, a recurrent neural network can analyze sensor data versus time to detect or predict a swipe direction, to perform handwriting recognition, etc. Sequential input data may include words in a sentence (e.g., for natural language processing, speech detection or processing, etc.); notes in a musical composition; sequential actions taken by a user (e.g., to detect or predict sequential application usage); sequential object states; etc.

Example recurrent neural networks include long short-term (LSTM) recurrent neural networks; gated recurrent units; bi-direction recurrent neural networks; continuous time recurrent neural networks; neural history compressors; echo state networks; Elman networks; Jordan networks; recursive neural networks; Hopfield networks; fully recurrent networks; sequence-to- sequence configurations; etc.

In some examples, machine learning module 313 can be or include one or more convolutional neural networks. In some instances, a convolutional neural network can include one or more convolutional layers that perform convolutions over input data using learned filters.

Filters can also be referred to as kernels. Convolutional neural networks can be especially useful for vision problems such as when input data 333 includes imagery such as still images or video. However, convolutional neural networks can also be applied for natural language processing.

In some examples, machine learning module 313 can be or include one or more generative networks such as, for example, generative adversarial networks. Generative networks can be used to generate new data such as new images or other content.

Machine learning module 313 may be or include an autoencoder. In some instances, the aim of an autoencoder is to learn a representation (e.g., a lower- dimensional encoding) for a set of data, typically for the purpose of dimensionality reduction. For example, in some instances, an autoencoder can seek to encode input data 333 and then provide output data that reconstructs input data 333 from the encoding. Recently, the autoencoder concept has become more widely used for learning generative models of data. In some instances, the autoencoder can include additional losses beyond reconstructing input data 333.

Machine learning module 313 may be or include one or more other forms of artificial neural networks such as, for example, deep Boltzmann machines; deep belief networks; stacked autoencoders; etc. Any of the neural networks described herein can be combined (e.g., stacked) to form more complex networks.

One or more neural networks can be used to provide an embedding based on input data 333. For example, the embedding can be a representation of knowledge abstracted from input data 333 into one or more learned dimensions. In some instances, embeddings can be a useful source for identifying related entities. In some instances, embeddings can be extracted from the output of the network, while in other instances embeddings can be extracted from any hidden node or layer of the network (e.g., a close to final but not final layer of the network). Embeddings can be useful for performing auto suggest next video, product suggestion, entity or object recognition, etc. In some instances, embeddings can be useful inputs for downstream models. For example, embeddings can be useful to generalize input data (e.g., search queries) for a downstream model or processing system.

Machine learning module 313 may include one or more clustering models such as, for example, k-means clustering models; k-medians clustering models; expectation maximization models; hierarchical clustering models; etc.

In some examples, machine learning module 313 can perform one or more dimensionality reduction techniques such as, for example, principal component analysis; kernel principal component analysis; graph-based kernel principal component analysis; principal component regression; partial least squares regression; Sammon mapping; multidimensional scaling; projection pursuit; linear discriminant analysis; mixture discriminant analysis; quadratic discriminant analysis; generalized discriminant analysis; flexible discriminant analysis; autoencoding; etc.

In some examples, machine learning module 313 can perform or be subjected to one or more reinforcement learning techniques such as Markov decision processes; dynamic programming; Q functions or Q-learning; value function approaches; deep Q-networks; differentiable neural computers; asynchronous advantage actor-critics; deterministic policy gradient; etc.

In some examples, machine learning module 313 can be an autoregressive model. In some instances, an autoregressive model can specify that output data 335 depends linearly on its own previous values and on a stochastic term. In some instances, an autoregressive model can take the form of a stochastic difference equation. One example autoregressive model is WaveNet, which is a generative model for raw audio.

In some examples, machine learning module 313 can include or form part of a multiple model ensemble. As one example, bootstrap aggregating can be performed, which can also be referred to as “bagging.” In bootstrap aggregating, a training dataset is split into a number of subsets (e.g., through random sampling with replacement) and a plurality of models are respectively trained on the number of subsets. At inference time, respective outputs of the plurality of models can be combined (e.g., through averaging, voting, or other techniques) and used as the output of the ensemble.

One example ensemble is a random forest, which can also be referred to as a random decision forest. Random forests are an ensemble learning method for classification, regression, and other tasks. Random forests are generated by producing a plurality of decision trees at training time. In some instances, at inference time, the class that is the mode of the classes (classification) or the mean prediction (regression) of the individual trees can be used as the output of the forest. Random decision forests can correct for decision trees' tendency to overfit their training set.

Another example ensemble technique is stacking, which can, in some instances, be referred to as stacked generalization. Stacking includes training a combiner model to blend or otherwise combine the predictions of several other machine-learned models. Thus, a plurality of machine-learned models (e.g., of same or different type) can be trained based on training data. In addition, a combiner model can be trained to take the predictions from the other machine-learned models as inputs and, in response, produce a final inference or prediction. In some instances, a single-layer logistic regression model can be used as the combiner model.

Another example of an ensemble technique is boosting. Boosting can include incrementally building an ensemble by iteratively training weak models and then adding to a final strong model. For example, in some instances, each new model can be trained to emphasize the training examples that previous models misinterpreted (e.g., misclassified). For example, a weight associated with each of such misinterpreted examples can be increased. One common implementation of boosting is AdaBoost, which can also be referred to as Adaptive Boosting. Other example boosting techniques include LPBoost; TotalBoost; BrownBoost; xgboost; MadaBoost, LogitBoost, gradient boosting; etc. Furthermore, any of the models described above (e.g., regression models and artificial neural networks) can be combined to form an ensemble. As an example, an ensemble can include a top level machine-learned model or a heuristic function to combine and/or weight the outputs of the models that form the ensemble.

In some examples, multiple machine-learned models (e.g., that form an ensemble can be linked and trained jointly (e.g., through backpropagation of errors sequentially through the model ensemble). However, in some examples, only a subset (e.g., one) of the jointly trained models is used for inference.

In some examples, machine learning module 313 can be used to preprocess input data 333 for subsequent input into another model. For example, machine learning module 313 can perform dimensionality reduction techniques and embeddings (e.g., matrix factorization, principal components analysis, singular value decomposition, word2vec/GLOVE, and/or related approaches); clustering; and even classification and regression for downstream consumption.

As discussed above, machine learning module 313 can be trained or otherwise configured to receive input data 333 and, in response, provide output data 335. Input data 333 can include different types, forms, or variations of input data. As examples, in various implementations, input data 333 can include features that describe the content (or portion of content) initially selected by the user, e.g., content of user-selected document or image, links pointing to the user selection, links within the user selection relating to other files available on device or cloud, metadata of user selection, etc. Additionally, with user permission, input data 333 includes the context of user usage, either obtained from the app itself or from other sources. Examples of usage context include breadth of share (sharing publicly, or with a large group, or privately, or a specific person), context of share, etc. When permitted by the user, additional input data can include the state of the device, e.g., the location of the device, the apps running on the device, etc.

In some examples, machine learning module 313 can receive and use input data 333 in its raw form. In some examples, the raw input data can be preprocessed. Thus, in addition or alternatively to the raw input data, machine learning module 313 can receive and use the preprocessed input data.

In some examples, preprocessing input data 333 can include extracting one or more additional features from the raw input data. For example, feature extraction techniques can be applied to input data 333 to generate one or more new, additional features. Example feature extraction techniques include edge detection; corner detection; blob detection; ridge detection; scale-invariant feature transform; motion detection; optical flow; Hough transform; etc.

In some examples, the extracted features can include or be derived from transformations of input data 333 into other domains and/or dimensions. As an example, the extracted features can include or be derived from transformations of input data 333 into the frequency domain. For example, wavelet transformations and/or fast Fourier transforms can be performed on input data 333 to generate additional features.

In some examples, the extracted features can include statistics calculated from input data 333 or certain portions or dimensions of input data 333. Example statistics include the mode, mean, maximum, minimum, or other metrics of input data 333 or portions thereof.

In some examples, as described above, input data 333 can be sequential in nature. In some instances, the sequential input data can be generated by sampling or otherwise segmenting a stream of input data. As one example, frames can be extracted from a video. In some examples, sequential data can be made non-sequential through summarization.

As another example preprocessing technique, portions of input data 333 can be imputed. For example, additional synthetic input data can be generated through interpolation and/or extrapolation.

As another example preprocessing technique, some or all of input data 333 can be scaled, standardized, normalized, generalized, and/or regularized. Example regularization techniques include ridge regression; least absolute shrinkage and selection operator (LASSO); elastic net; least-angle regression; cross-validation; L1 regularization; L2 regularization; etc. As one example, some or all of input data 333 can be normalized by subtracting the mean across a given dimension’s feature values from each individual feature value and then dividing by the standard deviation or other metric.

As another example preprocessing technique, some or all or input data 333 can be quantized or discretized. In some cases, qualitative features or variables included in input data 333 can be converted to quantitative features or variables. For example, one hot encoding can be performed.

In some examples, dimensionality reduction techniques can be applied to input data 333 prior to input into machine learning module 313. Several examples of dimensionality reduction techniques are provided above, including, for example, principal component analysis; kernel principal component analysis; graph-based kernel principal component analysis; principal component regression; partial least squares regression; Sammon mapping; multidimensional scaling; projection pursuit; linear discriminant analysis; mixture discriminant analysis; quadratic discriminant analysis; generalized discriminant analysis; flexible discriminant analysis; autoencoding; etc.

In some examples, during training, input data 333 can be intentionally deformed in any number of ways to increase model robustness, generalization, or other qualities. Example techniques to deform input data 333 include adding noise; changing color, shade, or hue; magnification; segmentation; amplification; etc.

In response to receipt of input data 333, machine learning module 313 can provide output data 335. Output data 335 can include different types, forms, or variations of output data. As examples, in various implementations, output data 335 can include content, either stored locally on the user device or in the cloud, that is relevantly shareable along with the initial content selection.

As discussed above, in some examples, output data 335 can include various types of classification data (e.g., binary classification, multiclass classification, single label, multi- label, discrete classification, regressive classification, probabilistic classification, etc.) or can include various types of regressive data (e.g., linear regression, polynomial regression, nonlinear regression, simple regression, multiple regression, etc.). In other instances, output data 335 can include clustering data, anomaly detection data, recommendation data, or any of the other forms of output data discussed above.

In some examples, output data 335 can influence downstream processes or decision making. As one example, in some examples, output data 335 can be interpreted and/or acted upon by a rules-based regulator.

Any of the different types or forms of input data described herein can be combined with any of the different types or forms of machine-learned models described herein to provide any of the different types or forms of output data described herein.

The systems and methods of the present disclosure can be implemented by or otherwise executed on one or more computing devices. Example computing devices include user computing devices (e.g., laptops, desktops, and mobile computing devices such as tablets, smartphones, wearable computing devices, etc.); embedded computing devices (e.g., devices embedded within a vehicle, camera, image sensor, industrial machine, satellite, gaming console or controller, or home appliance such as a refrigerator, thermostat, energy meter, home energy manager, smart home assistant, etc.); server computing devices (e.g., database servers, parameter servers, file servers, mail servers, print servers, web servers, game servers, application servers, etc.); dedicated, specialized model processing or training devices; virtual computing devices; other computing devices or computing infrastructure; or combinations thereof. A computing system that implements machine learning module 313 or other aspects of the present disclosure may include a number of hardware components that enable the performance of the techniques described herein.

In some instances, output data 335 obtained through machine learning module 313 at a computing system or device can be used to improve other device tasks or can be used by other non-user devices to improve services performed by or for such other non-user devices. For example, output data 335 can improve other downstream processes performed by a server device for a computing device of a user or embedded computing device. In other instances, output data 335 obtained through implementation of machine learning module 313 at a computing system or device can be sent to and used by a user computing device, an embedded computing device, or some other client device. In some examples, computing system 100 of FIG. 1 may perform machine learning as a service.

In yet other implementations, different respective portions of machine learning module 313 can be stored at and/or implemented by some combination of a user computing device; an embedded computing device; a server computing device; etc. In other words, portions of machine learning module 313 may be distributed in whole or in part amongst a client device (e.g., computing device 105 of FIG. 1) and a computing system (e.g., computing system 100 of FIG. 1).

A computing device such as computing device 105 of FIG. 1 may perform graph processing techniques or other machine learning techniques using one or more machine learning platforms, frameworks, libraries, etc.

In some examples, multiple instances of machine learning module 313 can be parallelized to provide increased processing throughput. For example, the multiple instances of machine learning module 313 can be parallelized on a single processing device or computing device or parallelized across multiple processing devices or computing devices.

A computing device that implements machine learning module 313 or other aspects of the present disclosure can include a number of hardware components that enable performance of the techniques described herein. For example, a computing device can include one or more memory devices that store some or all of machine learning module 313. For example, machine learning module 313 can be a structured numerical representation that is stored in memory. The one or more memory devices can also include instructions for implementing machine learning module 313 or performing other operations. Example memory devices include RAM, ROM, EEPROM, EPROM, flash memory devices, magnetic disks, etc., and combinations thereof.

A computing device can also include one or more processing devices that implement some or all of machine learning module 313 and/or perform other related operations. Example processing devices include one or more of: a central processing unit (CPU); a visual processing unit (VPU); a graphics processing unit (GPU); a tensor processing unit (TPU); a neural processing unit (NPU); a neural processing engine; a core of a CPU, VPU, GPU, TPU, NPU or other processing device; an application specific integrated circuit (ASIC); a field programmable gate array (FPGA); a co-processor; a controller; or combinations of the processing devices described above. Processing devices can be embedded within other hardware components such as, for example, an image sensor, accelerometer, etc.

Hardware components (e.g., memory devices and/or processing devices) can be spread across multiple physically distributed computing devices and/or virtually distributed computing systems.

In some examples, machine learning module 313 described herein can be included in different portions of computer-readable code on a computing device. In one example, machine learning module 313 can be included in a particular application or program and used (e.g., exclusively) by such a particular application or program. Thus, in one example, a computing device can include a number of applications and one or more of such applications can contain its own respective machine learning library and machine-learned model(s).

In another example, machine learning module 313 described herein can be included in an operating system of a computing device (e.g., in a central intelligence layer of an operating system) and can be called or otherwise used by one or more applications that interact with the operating system. In some examples, each application can communicate with the central intelligence layer (and model(s) stored therein) using an application programming interface (API) (e.g., a common, public API across all applications).

In some examples, the central intelligence layer can communicate with a central device data layer. The central device data layer can be a centralized repository of data for computing device 105. The central device data layer can communicate with a number of other components of computing device 105, such as, for example, one or more sensors, a context manager, a device state component, and/or additional components. In some examples, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination.

Databases and applications can be implemented on a single system or distributed across multiple systems. Distributed components can operate sequentially or in parallel.

In addition, the machine learning techniques described herein are readily interchangeable and combinable. Although certain example techniques have been described, many others exist and can be used in conjunction with aspects of the present disclosure.

Further to the descriptions above, a user may be provided with controls that enable the user to make an election as to both if and when systems, programs or features described herein may enable collection of user information (e.g., information about a user’s social network, social actions or activities, profession, a user’s preferences, or a user’s current location), and if the user is sent content or communications from a server. In addition, certain data may be treated in one or more ways before it is stored or used, so that personally identifiable information is removed.

For example, a user’s identity may be treated so that no personally identifiable information can be determined for the user, or a user’s geographic location may be generalized where location information is obtained (such as to a city, ZIP code, or state level), so that a particular location of a user cannot be determined. Thus, the user may have control over what information is collected about the user, how that information is used, and what information is provided to the user.

FIG. 3C is a conceptual diagram illustrating a machine learning module configured to apply an on-device model, in accordance with one or more aspects of the present disclosure. Machine learning module 313 of FIG. 3C may be an example of machine learning module 313 of FIGS. 3A and 3B. In general, ML module 313 can be or include one or more transformer-based neural networks, such as a large language model module 342. In general, language model module 342 may apply an LLM to multimodal input to identify one or more tasks. In some examples, language model module 342 may apply an LLM to other information stored by computing system 100 (e.g., retrieved application data, context information, etc.) to determine, for each of the one or more tasks, one or more associated applications, in which each of the one or more associated applications includes one or more functions for performing a respective task.

Language model module 342 may implement, for example, the Pathways Language Model developed by Google. Transformer-based neural networks may refer to a type of deep learning architecture specifically designed for handling sequential data, such as text or time series. In other words, transformer-based neural networks like LLMs may be configured to perform natural language processing (NLP) tasks, such as question-answering, machine translation, text summarization, and sentiment analysis. Language model module 342 may be configured to perform tasks such as classification, sentiment analysis, entity extraction, extractive question answering, summarization, re-writing text in a different style, ad copy generation, and concept ideation.

Transformer-based neural networks may utilize a self-attention mechanism, which allows the model to weigh the importance of different elements in a given input sequence relative to each other. The self-attention mechanism may help language model module 342 effectively capture long-range dependencies and complex relationships between elements, such as words in a sentence.

Language model module 342 may include an encoder and a decoder that operate to process and generate sequential data, such as structured text. Both the encoder and decoder may include one or more of self-attention mechanisms, position-wise feedforward networks, layer normalization, or residual connections. In some examples, the encoder may process an input sequence and create a representation that captures the relationships and context among the elements in the sequence. The decoder may then obtain the representation generated by the encoder and produce an output sequence. In some examples, the decoder may generate the output one element at a time (e.g., one word at a time), using a process called autoregressive decoding, where the previously generated elements are used as input to predict the next element in the sequence.

In some examples, language model module 342 may determine a set of information types included in the input. An information type may be or otherwise include a topic, theme, point, subject, purpose, intent, keyword, etc. In some examples, language model module 342 may determine the information type by leveraging a self-attention mechanism to capture the relationships and dependencies between words in the input sequence. For example, language model module 342 may tokenize (e.g., split) a sequence of words or subwords, which language model module 342 may convert into vectors (e.g., numerical representations) that language model module 342 can process. Language model module 342 may use the self-attention mechanism to weigh the importance of each token in relation to the others. In this way, language model module 342 may identify patterns and relationships between the tokens, and in turn the words corresponding to the tokens, that indicate one or more information types.

In general, language model module 342 may excel at performing NLP tasks, such as generating text and other content (e.g., new code that generates GUIs, graphical components, and/or functionality for performing one or more tasks). However, with respect to specific types of content (e.g., specific information types), language model module 342 may have an increased likelihood of generating false, inaccurate, or bad quality information. To address this issue, language model module 342 may be configured to exclude the generation of content or code relating to a set of excluded information types. For example, the set of excluded information types may include one or more of phone numbers, addresses, web addresses, functionality prohibited by an application, sensitive data (e.g., full bank account information), etc. Thus, input information may be passed in language model module 342 with certain prerequisites, prompts, or “rules” that can be stored in rules storage 344. Machine learning module 313 may apply these prerequisites, prompts, or rules when generating the set of instructions for generating the GUIs and graphical components associated with the functionality for performing the identified tasks.

In some examples, machine learning module 313 may use accessibility information when generating output. In some examples, the rules may be text inputs such as, for example, “Do not display more than 25 characters in a widget.” As such, rules storage 344 may store a plurality of text inputs and/or other data that further specify how instructions file 350 should be generated by machine learning module 313. For example, language model module 342 may be applied to the context information in accordance with the one or more predefined rules stored in rules storage 344, which may include, for example, unauthorized terms, unauthorized amounts of data (e.g., such that the response does not exceed the bandwidth of the satellite connection), etc. Because language model module 342 can interpret the rules along with the input, computing system 100 may provide more accurate instructions for generating output.

While language model module 342 may be a transformer-based neural network in some examples, in some other examples, language model module 342 may be or otherwise include one or more other types of neural networks. For example, language model module 342 may be or include an autoencoder. In some examples, the aim of an autoencoder is to learn a representation (e.g., a lower- dimensional encoding) for a set of data, typically for the purpose of dimensionality reduction. For example, in some examples, an autoencoder can seek to encode the input data and then provide output data that reconstructs the input data from the encoding. In some examples, the autoencoder can include additional losses beyond reconstructing the input data. Language model module 342 may be or include one or more other forms of artificial neural networks such as, for example, deep Boltzmann machines, deep belief networks, stacked autoencoders, etc. Any of the neural networks described herein can be combined (e.g., stacked) to form more complex networks.

Generally, large language models can be slow and expensive in terms of carbon, energy usage, and financial cost. Thus, in some examples, machine learning module 313 may minimize how often language model module 342 is invoked by caching generated instructions, or new code, in instructions cache 348. For example, in some examples, language model module 342 may use a prompt including the context information retrieved by computing system 100. At runtime, more specific details may be gathered (e.g., via the API), such that the generated instructions or code may be reused. Specifically, machine learning module 313 may be configured to perform instruction embedding in which a representation (i.e., embedding) of frequently used or critical instructions are stored in instructions cache 348.

In various examples, instructions file 350 may be generated based on the instructions stored in instructions cache 348 and any additional instructions or information not present in instructions cache 348. For example, machine learning module 313 may receive additional user input and/or information, and may use the cached instructions at runtime to generate instructions file 350. By storing frequently used or critical instructions in instructions cache 348, machine learning module 313 may reuse the frequently used or critical instructions without having to invoke language model module 342 on data other than what is included in new context information or input (e.g., language model module 342 may not have to re-apply the large language model to all stored context information). In some examples, machine learning module 313 may apply code caching to both compiled and interpreted languages. Machine learning module 313 may implement various types of caching, such as, for example, Just-In-Time (JIT) compilation, Ahead-Of-Time (AOT) compilation, and bytecode caching.

In some examples, instructions file 350 may include all data collected or used by computing system 100 to generate instructions file 350. For example, instructions file 350 may include details for how the user's natural language was resolved into working code. In some examples, users may be able to view or “inspect” instructions file 350. In other words, a user may be provided various controls to clarify, inspect, or stop a task to ensure that computing system 100 is following the user’s intent.

As such, by leveraging one or more of the machine learning techniques described herein, the information retrieval performed by computing device 105 may require less time and/or computational resources, as computing device 105 may enable computing system 100 to perform more computationally expensive tasks required for answering user queries.

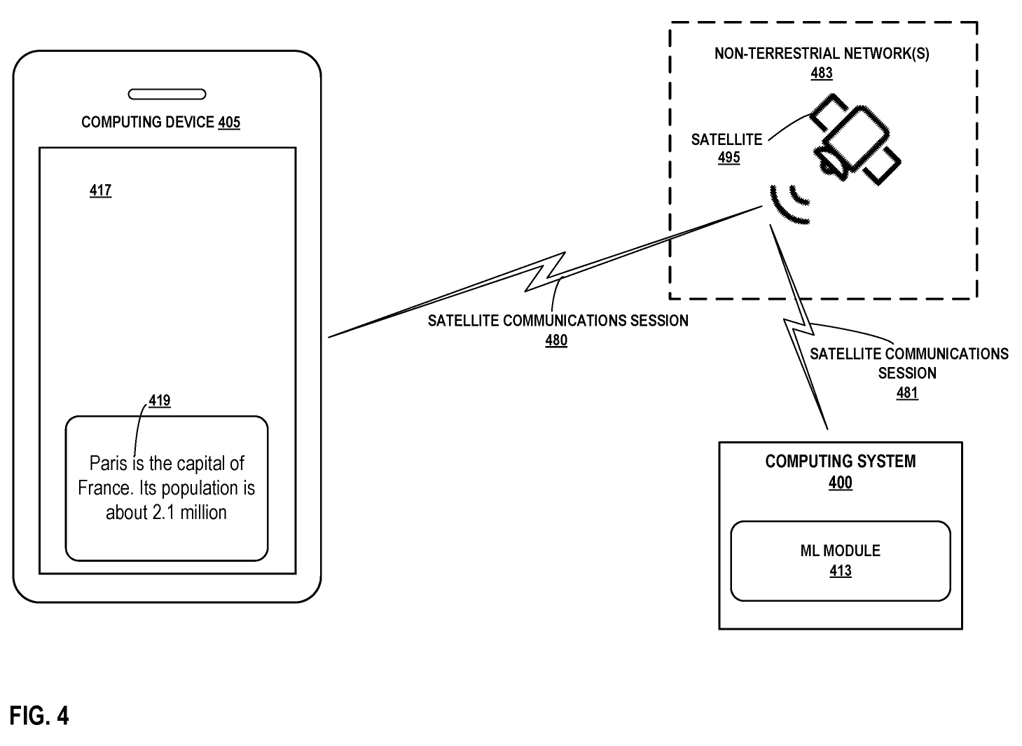

FIG. 4 is a block diagram illustrating another example computing device configured to use non-terrestrial networks, in accordance with one or more techniques of this disclosure. FIG. 4 includes computing device 405, satellite communications session 480, non-terrestrial network(s) 483, satellite 495, satellite communications session 481, computing system 400, and ML module 413, which may be similar if not substantially similar to computing device 105, satellite communications session 180, non-terrestrial network(s) 183, satellite 195, satellite communications session 181, computing system 100, and ML module 113, respectively.

In the example of FIG. 4, computing device 405 may establish satellite communications session 480 with at least one accessible non-terrestrial network 483. While connected to the at least one accessible non-terrestrial network 483, computing device 405 may receive data indicative of at least one user input. For instance, a user may provide a natural language audio input such as, “Tell me about the capital of France and its population.” Computing device 405 may determine whether an amount of the data exceeds a maximum amount of data that can be transmitted via satellite communications session 480 within a predetermined time frame (e.g., whether the query would require a bandwidth that exceeds the bandwidth of satellite communications session 480 and/or non-terrestrial network 483). More specifically, computing device 405 may determine whether satellite communications session 480 has enough available bandwidth to transmit the user query to computing system 400, which can process, analyze, and provide output for the natural language audio input. For instance, computing system 400 may include ML module 113, which may be or include a large language model capable of processing the natural language audio input.

In some examples, computing device 405 may determine that the data indicative of the user input needs to be modified (e.g., reduced, compressed, summarized, etc.), e.g., due to the limited bandwidth of the satellite connection. As such, responsive to determining the amount of the data exceeds a maximum amount of data, computing device 405 may apply one or more transformations to the data to reduce the data. In some examples, computing device 405 may apply ML module 112 of FIG. 1 to the data indicative of the user input to generate modified data. For example, the transformations may include one or more of feature selection, data compression, data summarization, redundant data removal, approximate data processing, encoding, tokenization, data caching, data merging, etc. Then, responsive to determining an amount of the modified data does not exceed the maximum amount of data, computing device 405 may transmit, to computing system 400 and via satellite communications session 480, the modified data. More specifically, computing device 405 may transmit the modified data to satellite 495 via satellite communications session 480, in which satellite 495 may forward the modified data to computing system 400 via satellite communications session 481.

In some examples, responsive to determining the amount of the modified data exceeds the maximum amount of data, computing device 405 may generate, for display by at least one user interface device (e.g., one or more user interface devices from UID 104 of FIG. 1), a notification to indicate that the at least one text output cannot be generated. For example, widget 419, which may represent a text box or some other smaller GUI or graphical component overlaid GUI 417, may be updated to include the notification. In these examples, the notification may further prompt the user to provide another input that is less complex, i.e., data indicative of an input associated with an amount of data that does not exceed the maximum amount of data. In some examples, the notification may include at least one suggested input associated with an amount of data that does not exceed the maximum amount of data. For example, in one example, a user may provide an input such as, “Can you please tell me the best way to get to 123 Main Street, Chicago, Illinois by car and what my arrival time will be?” Computing device 405 may determine that the user’s input includes an amount of data that exceeds the maximum amount of data, and may generate a suggested input such as, “Directions to 123 Main Street, Chicago, IL.” In some examples, computing device 405 may generate the at least one suggested input for display in widget 419, in which the user may select a suggested input and/or confirm a suggested input. In some examples, the notification may include instructions, tips, other suggestions, etc. for how a user can modify, e.g., simplify, their query. For example, in another example, computing device 405 may determine that the user’s input includes an amount of data that exceeds the maximum amount of data, and may generate output including text such as, “Please shorten your query to a few words,” “Please only state the address,” etc. In some examples, computing device 405 may use one or more machine learning techniques (e.g., may use ML module 112 of FIG. 1) to generate the at least one suggested input, instructions, tips, other suggestions, etc.

In some examples, computing device 405 may also transmit a prompt, in which the prompt is indicative of context information for computing device 405 (e.g., information associated with a location of computing device 405, an indication of satellite communications session 480 with non-terrestrial network 483, an indication of one or more wireless communications networks being outside of an accessibility range of computing device 405 for an amount of time, an indication of a cellular signal strength of computing device 405 being below a threshold for an amount of time, etc.). In some examples, with explicit user consent, computing device 405 may transmit, to computing system 400, information indicative of a current location of computing device 405 (e.g., the prompt may include location information for computing device 405). For example, in one example, a user may request simple location-based text directions. For instance, a stranded user may ask directions to a nearby point of interest. In some examples, computing system 400 may retrieve information pertaining to one or more relevant points of interest based on the location information for computing device 405. That is, in some examples, based on this location information, computing system 400 may generate a text summary of relevant nearby information for computing device 405 (e.g., information such as "nearest water source,” "closest known shelter," “nearest cell tower,” "simplest hiking trail to this location," "best stargazing spot with clear skies nearby," etc.). That is, ML module 413 may understand a user's needs based on limited text inputs, and then provide concise and helpful information as a response. In general, ML module 413 may limit the amount of data included in a response while still keeping enough information content in the response.

In some examples, the prompt may include a session identifier. In some examples, each user input may be associated with a session identifier, such that one or more user inputs may be associated with the same session identifier. For example, a natural language audio input such as, “Tell me about the capital of France and its population," may be a first user input associated with a particular session identifier. Based on this first user input, which may or may not be modified to accommodate the bandwidth of the non-terrestrial (e.g., satellite) connection, and the prompt, computing system 400 may generate at least one text output. For example, computing system 400 may generate a first text output such as, “Paris is the capital of France. Its population is about 2.1 million.” In some examples, an amount of data indicative of a text output may be reduced by computing system 400 using ML module 413, such as to meet bandwidth constraints. For example, in some examples, the prompt received by ML module 413 may include information indicative of the specific bandwidth constraints for computing device 105 in satellite communications session 480. In some examples, a communication session with computing device 405 may be allocated a maximum amount of data, and the prompt received by ML module 413 may include information indicative of the maximum amount of data. As such, in general, the responses generated by computing system 400 may be modified and/or optimized to align with any bandwidth or data constraints associated with satellite communications session 480 that is established between computing device 405 and satellite 495. In some examples, computing system 400 may determine that the data indicative of at least one text output needs to be modified (e.g., reduced, compressed, summarized, etc.) prior to transmitting the data indicative of the at least one text output to computing device 405. As such, in some examples, computing system 400 may apply one or more transformations to the data indicative of the at least one text output to reduce the amount of the data. As an example, computing system 400 may reduce (e.g., using ML module 413) “Paris is the capital of France. Its population is about 2.1 million,” to “Paris. 2.1 million.” Computing system 400 may transmit, to computing device 405, the modified data indicative of the at least one text output.

That is, in general, computing system 400 may receive, from computing device 405 via a connection (e.g., satellite communications session 481) with at least one accessible non-terrestrial network 483, a prompt and data indicative of at least one user input, in which the prompt is indicative of context information for a computing device, such as computing device 405. Specifically, computing device 405 may transmit the prompt and data indicative of the at least one user input to satellite 495 via satellite communications session 480, and satellite 495 may further transmit the prompt and data indicative of the at least one user input to computing system 400 via satellite communications session 481. Computing system 400 may apply ML module 413 including one or more machine learning models to the prompt and the data indicative of the at least one user input to generate data indicative of at least one output (e.g., a response, such as at least one text output). In some examples, computing system 400 may determine whether an amount of the data indicative of the at least one output exceeds a maximum amount of data that can be transmitted via satellite communications session 480 within a predetermined time frame (e.g., whether the response would require a bandwidth that exceeds the bandwidth of satellite communications session 480, satellite communications session 481, and/or non-terrestrial network 483). In some examples, additionally or alternatively, computing system 400 may determine whether an amount of the data indicative of the at least one output exceeds data size limitations imposed by the available bandwidth of the non-terrestrial network connection(s) (e.g., satellite communications session 480 and/or satellite communications session 481). In some examples, additionally or alternatively, computing system 400 may determine whether one or more received user queries and/or one or more generated responses exceeds a quota allocated to a user, e.g., a data quota for a particular session, a data quota for a predetermined time duration, etc. In the example of FIG. 4, computing system 400 may determine, e.g., based on the prompt received from computing device 405, whether satellite communications session 480 has enough available bandwidth to transmit a response generated by computing system 400, e.g., at least one text output, to computing device 405. Responsive to determining the amount of the data indicative of the at least one output exceeds the maximum amount of data, computing system 400 may generate modified data indicative of the at least one output by applying one or more transformations to the data indicative of the at least one output. For instance, computing system 400 may apply ML module 413 to the data indicative of the at least one output to apply the one or more transformations, to modify, and/or to optimize the data indicative of the at least one output. Example transformations may include one or more of feature selection, data compression, data summarization, redundant data removal, approximate data processing, encoding, tokenization, data caching, data merging, etc. Responsive to determining an amount of the modified data indicative of the at least one output does not exceed the maximum amount of data, computing system 400 may transmit, to computing device 405 via the connection (e.g., satellite communications session 481 and satellite communications session 480, which may together may represent a communications session between computing system 400 and computing device 405 using non-terrestrial network 483, with satellite 495 acting as an intermediary), the modified data indicative of the at least one output.

Computing device 405 may receive, from computing system 400 and via the satellite connection, the data indicative of the at least one text output, which may have been modified. Computing device 405 may generate, for display by a user interface device (e.g., a device screen that displays GUI 417), the at least one text output, e.g., in widget 419. For example, widget 419 may be updated to include the first text output such as, “Paris is the capital of France. Its population is about 2.1 million.”

In some examples, computing device 405 and/or computing system 400 may store the data indicative of the first user input and the first text output with the session identifier in a memory. In one example, computing device 405 may receive data indicative of a second user input associated with the session identifier, e.g., a natural language audio input such as, “What is the GDP of Paris, the capital of France?” Computing device 405 may determine whether an amount of the data indicative of the second user input exceeds the maximum amount of data. Responsive to determining the amount of the data indicative of the second user input exceeds the maximum amount of data, computing device 405 may apply the transformations to the data indicative of the second user input to generate modified data indicative of the second user input, in which the transformations may be based on the first text output. For example, computing device 405 may apply a transformation such as context optimization. That is, computing device 405 may use the information stored for the session identifier to optimize and/or modify data indicative of any additional user inputs provided during the session. Furthermore, computing device 405 may transmit data to computing system 400 with the respective session identifier, such that computing system 400 can infer input and make assumptions using the information provided throughout the session as context. As such, computing system 400 may also use information stored for the session identifier to optimize and/or modify data indicative of any additional outputs provided during the session.

Thus, in general, computing device 405 and/or computing system 400 may perform context-aware query handling and/or processing, e.g., by using the session identifier. In some examples, computing system 400 may store each query received from computing device 405 in a memory with a respective session identifier. That is, computing system 400 may maintain context for a particular session, and ML module 413 may use the context to provide optimized (e.g., shorter) and/or modified responses that align with satellite communications session 480 constraints. Continuing the example, computing device 405 may reduce “What is the GDP of Paris, the capital of France?” to “What is its GDP?”. Computing system 400 may apply ML module 413 to the modified second input associated with the session identifier, and based on the first user input and the first text output associated with the same session identifier, ML module 413 may generate a second text output, such as “$1.064 trillion.” Computing device 405 may receive the second text output from computing system 400, and generate, for display by at least one user interface device (e.g., one or more user interface devices from UID 104 of FIG. 1), the second text output. For example, widget 419 may be updated to include the second text output. Computing device 405 may store the second text output with the session identifier in the memory, such as to perform context optimization. In some examples, widget 419 may be updated to include text indicative of one or more user inputs and one or more generated outputs associated with a particular session. For example, widget 419 may be a chat log, e.g., widget 419 may include a textual representation of a conversation between a user and computing device 105 during a particular session. In some examples, widget 419 may be scrollable. In some examples, widget 419 may be an interactive user interface element (e.g., a user may select icons, buttons, text, suggested text input, etc. that may be included in widget 419 (not shown in FIG. 4)). In some examples, one or more visual effects or characteristics of widget 419 may be added and/or edited. For example, a user may expand widget 419 such that widget 419 includes more of the

text representing the conversation between the user and computing device 405 during a particular session. In some examples, responsive to computing device 405 determining a particular session has ended (e.g., based on additional user input not being received for a predetermined time duration, an indication from the user to end the session, ML module 112 determining that a topic of the session conversation has changed, etc.), widget 419 may be updated to no longer include the textual representation of the conversation between the user and computing device 105 during the session. In some examples, responsive to computing device 105 determining a particular session has ended, computing device 405 may store, at least temporarily, information pertaining to a particular session in a memory. In some examples, a user may continue a particular session after computing device 405 determines the session has ended (e.g., based on user input indicating the user would like to continue the session, based on ML module 112 determining that a topic of a user input is associated with a previous session, etc.). In some examples, computing device 105 may store information pertaining to restrictions on a number of messages users query for free during a particular session or while using satellite communication. In some examples, monetary charges may be applied for extra messaging service (e.g., to control the number of messages exchanged between computing device 105 and computing system 100 while computing device 105 is using satellite communication).

Thus, in general, by integrating computing system 400, users may build context over multiple queries and maintain a conversation history on the server to refine information requests. The on-device models included in computing device 105 (e.g., ML module 112 of FIG. 1) may be integrated to translate user requests (e.g., complex queries, voice input, etc.) into concise, bandwidth-friendly queries. In this way, the techniques described herein may address bandwidth limitations in communication between computing devices and ground-based servers via non-terrestrial networks. That is, the techniques described herein provide solutions for more efficient utilization of satellite bandwidth through concise communication. For instance, by optimizing, modifying, and/or handling queries and responses based on context information, the amount of data that is transmitted over a non-terrestrial network may be reduced, which may increase response times and thus overall user experience. Furthermore, the techniques described herein may provide solutions for enabling more computationally powerful machine learning models, such as large language models, for information retrieval over networks with limited bandwidth, such as satellite communications networks. By using on-device methods to reduce the amount of user queries, more advanced machine learning capabilities may still be accessible to users, and furthermore, response time may be reduced, which may improve overall user experience with devices connected to satellite communications networks. As such, by providing a low-bandwidth, text-based interface for information retrieval and basic services, the techniques described herein may provide solutions for integrating artificial intelligence (AI)-based chatbots or other information retrieval applications with satellite communication infrastructure.

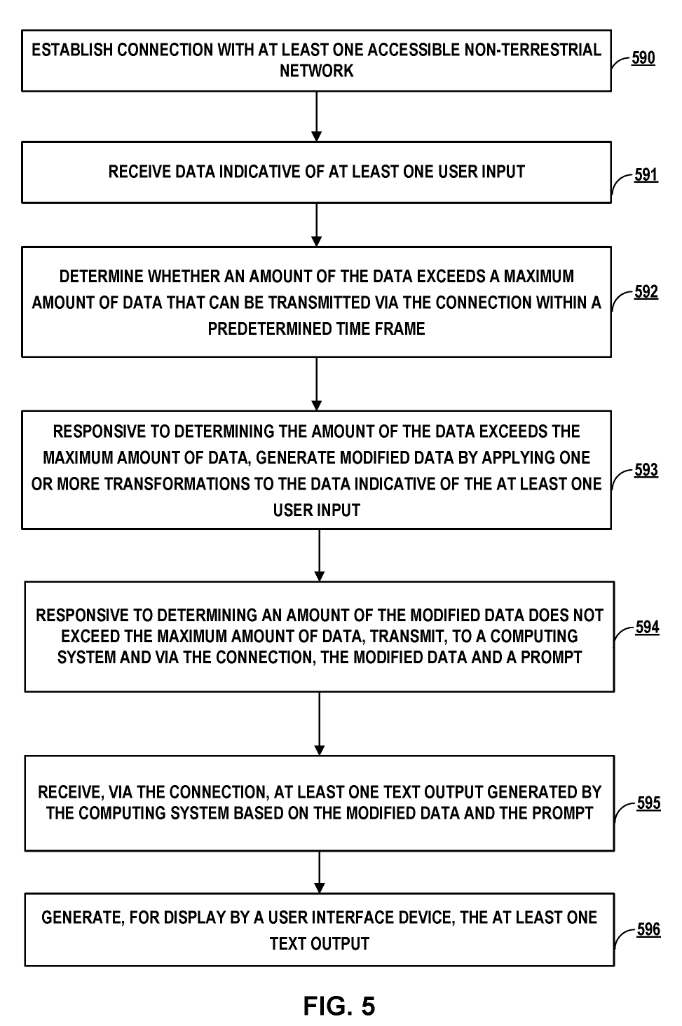

FIG. 5 is a flow chart illustrating an example mode of operation for a computing device to communicate with a computing system for information retrieval over non-terrestrial networks, in accordance with techniques of this disclosure. For clarity, the example of FIG. 5 may be described in reference to FIGS. 1-4.

Computing device 105 establishes satellite communications session 180 with at least one accessible non-terrestrial network 183 (590). Computing device 105 receives data indicative of at least one user input (591). In some examples, the user input includes one or more of a text input and an audio input. Computing device 105 determines whether an amount of the data exceeds a maximum amount of data that can be transmitted via satellite communications session 180 within a predetermined time frame (592). Responsive to determining the amount of the data exceeds the maximum amount of data, computing device 105 generates modified data by applying one or more transformations to the data indicative of the at least one user input (593). In some examples, to generate the modified data by applying the one or more transformations to the data indicative of the at least one user input, computing device 105 generates the modified data by applying ML module 112 to the data indicative of the at least one user input. In some examples, the one or more transformations include one or more of feature selection, data compression, data summarization, redundant data removal, approximate data processing, encoding, tokenization, data caching, and data merging.

Responsive to determining an amount of the modified data does not exceed the maximum amount of data, computing device 105 transmits, to computing system 100 via satellite communications session 180, the modified data and a prompt (594). In some examples, the prompt is indicative of context information for the computing device 105. In some examples, the context information for computing device 105 includes one or more of information associated with a location of computing device 105, an indication of satellite communications session 180 with at least one accessible non-terrestrial network 183, an indication of one or more wireless communications networks being outside of an accessibility range of computing device 105 for an amount of time, and an indication of a cellular signal strength of computing device 105 being below a threshold for an amount of time. Computing device 105 receives, from computing system 100 via satellite communications session 180, at least one text output generated by computing system 100 based on the modified data and the prompt (595). In some examples, the at least one text output generated by computing system 100 is at least one modified text output generated by computing system 100. In some examples, an amount of data indicative of the at least one modified text output does not exceed the maximum amount of data. Computing device 105 generates, for display by UID 104, the at least one text output (596).

In some examples, responsive to determining the amount of the modified data exceeds the maximum amount of data, computing device 105 generates, for display by UID 104, a notification to indicate that the at least one text output cannot be generated. In some examples, the data indicative of the user input is data indicative of a first user input, and the notification further prompts a user to provide data indicative of a second user input associated with an amount of data that does not exceed the maximum amount of data. In some examples, widget 419 of GUI 417 is updated to include the notification.

In some examples, the at least one user input is a first user input associated with a session identifier, and the at least one text output is a first text output associated with the session identifier. In some examples, computing device 105 stores the data indicative of the first user input and the first text output with the session identifier in one or more storage devices 208. In some examples, computing device 105 receives data indicative of a second user input associated with the session identifier. In some examples, computing device 105 determines whether an amount of the data indicative of the second user input exceeds the maximum amount of data. In some examples, responsive to determining the amount of the data indicative of the second user input exceeds the maximum amount of data, computing device 105 generates modified data indicative of the second user input by applying one or more transformations to the data indicative of the second user input. In some examples, the one or more transformations are based on the first text output. In some examples, responsive to determining an amount of the modified data indicative of the second user input does not exceed the maximum amount of data, computing device 105 transmits, to computing system 100 via satellite communications session 180, the session identifier and the modified data indicative of the second user input. In some examples, computing device 105 receives, from computing system 100 via satellite communications session 180, a second text output generated by computing system 100 based on the modified data indicative of the second user input. In some examples, computing device 105 generates, for display by UID 104, the second text output. In some examples, computing device 105 stores the data indicative of the second user input and the second text output with the session identifier in one or more storage devices 208.

Thus, the techniques described herein may provide multiple benefits to bandwidth-constrained networks. For instance, by optimizing and/or modifying user queries, as well as responses to the user queries, the techniques described may reduce the amount of data transmitted over the bandwidth-constrained network, which may lead to lower latency and improved responsiveness. Additionally, the techniques described may minimize the impact of network interruptions and fluctuations in bandwidth, and may help to conserve battery power on computing devices by offloading processing to a remote system. Lastly, the techniques described may enable the use of computationally intensive LLMs that would otherwise be impractical over non-terrestrial networks. As such, users may enjoy greater functionality of their devices and improved information retrieval while connected to bandwidth-constrained networks, such as non-terrestrial networks.

This disclosure includes the following examples:

Example 1: A method includes establishing, by a computing device, a connection with at least one accessible non-terrestrial network; receiving, by the computing device, data indicative of at least one user input; determining, by the computing device, whether an amount of the data exceeds a maximum amount of data that can be transmitted via the connection within a predetermined time frame; responsive to determining the amount of the data exceeds the maximum amount of data, generating, by the computing device, modified data by applying one or more transformations to the data indicative of the at least one user input; responsive to determining an amount of the modified data does not exceed the maximum amount of data, transmitting, by the computing device, and to a computing system via the connection, the modified data and a prompt, wherein the prompt is indicative of context information for the computing device; receiving, by the computing device, and via the connection, at least one text output generated by the computing system based on the modified data and the prompt; and generating, by the computing device, and for display by a user interface device, the at least one text output.

Example 2: The method of example 1, wherein the context information for the computing device includes one or more of: information associated with a location of the computing device, an indication of the connection with the at least one accessible non-terrestrial network, an indication of one or more wireless communications networks being outside of an accessibility range of the computing device for an amount of time, and an indication of a cellular signal strength of the computing device being below a threshold for an amount of time.

Example 3: The method of example 2, wherein the one or more wireless communications networks include one or more of a WI-FI network and a cellular communications network.

Example 4: The method of any of examples 1 through 3, wherein generating the modified data by applying the one or more transformations to the data indicative of the at least one user input further comprises: generating, by the computing device, the modified data by applying a machine learning model operating in a low power mode to the data indicative of the at least one user input, wherein the one or more transformations include one or more of feature selection, data compression, data summarization, redundant data removal, approximate data processing, encoding, tokenization, data caching, and data merging.

Example 5: The method of any of examples 1 through 4, the method further includes responsive to determining the amount of the modified data exceeds the maximum amount of data, generating, by the computing device, and for display by the user interface device, a notification to indicate that the at least one text output cannot be generated.

Example 6: The method of example 5, wherein the notification further includes at least one suggested input associated with an amount of data that does not exceed the maximum amount of data.

Example 7: The method of example 5, wherein the data indicative of the user input is data indicative of a first user input, and wherein the notification further prompts a user to provide data indicative of a second user input associated with an amount of data that does not exceed the maximum amount of data.

Example 8: The method of any of examples 1 through 7, wherein the user input includes one or more of a text input and an audio input.

Example 9: The method of any of examples 1 through 8, wherein the at least one user input is a first user input associated with a session identifier, wherein the at least one text output is a first text output associated with the session identifier, wherein the method further comprises: storing, by the computing device, the data indicative of the first user input and the first text output with the session identifier in a memory; receiving, by the computing device, data indicative of a second user input associated with the session identifier; determining, by the computing device, whether an amount of the data indicative of the second user input exceeds the maximum amount of data; responsive to determining the amount of the data indicative of the second user input exceeds the maximum amount of data, generating, by the computing device, modified data indicative of the second user input by applying one or more transformations to the data indicative of the second user input, wherein the one or more transformations are based on the first text output; responsive to determining an amount of the modified data indicative of the second user input does not exceed the maximum amount of data, transmitting, by the computing device, and to the computing system via the connection, the session identifier and the modified data indicative of the second user input; receiving, by the computing device, and via the connection, a second text output generated by the computing system based on the modified data indicative of the second user input; generating, by the computing device, and for display by the user interface device, the second text output; and storing, by the computing device, the data indicative of the second user input and the second text output with the session identifier in the memory.

Example 10: The method of any of examples 1 through 9, wherein the at least one text output generated by the computing system is at least one modified text output generated by the computing system, and wherein an amount of data indicative of the at least one modified text output does not exceed the maximum amount of data.

new paragraph...

Example 11: A computing device includes one or more processors; and one or more storage devices that store instructions, wherein the instructions, when executed by the one or more processors, cause the one or more processors to: establish a connection with at least one accessible non-terrestrial network; receive data indicative of at least one user input; determine whether an amount of the data exceeds a maximum amount of data that can be transmitted via the connection within a predetermined time frame; responsive to determining the amount of the data exceeds the maximum amount of data, generate modified data by applying one or more transformations to the data indicative of the at least one user input; responsive to determining an amount of the modified data does not exceed the maximum amount of data, transmit, to a computing system via the connection, the modified data and a prompt, wherein the prompt is indicative of context information for the computing device; receive, via the connection, at least one text output generated by the computing system based on the modified data and the prompt; and generate, for display by a user interface device, the at least one text output.

Example 12: The computing device of example 11, wherein the context information for the computing device includes one or more of: information associated with a location of the computing device, an indication of the connection with the at least one accessible non-terrestrial network, an indication of one or more wireless communications networks being outside of an accessibility range of the computing device for an amount of time, and an indication of a cellular signal strength of the computing device being below a threshold for an amount of time.

Example 13: The computing device of example 12, wherein the one or more wireless communications networks include one or more of a WI-FI network and a cellular communications network.

Example 14: The computing device of any of examples 11 through 13, wherein to generate the modified data by applying the one or more transformations to the data indicative of the at least one user input, the instructions further cause the one or more processors to: generate the modified data by applying a machine learning model operating in a low power mode to the data indicative of the at least one user input, wherein the one or more transformations include one or more of feature selection, data compression, data summarization, redundant data removal, approximate data processing, encoding, tokenization, data caching, and data merging.

Example 15: The computing device of any of examples 11 through 14, wherein the instructions further cause the one or more processors to: responsive to determining the amount of the modified data exceeds the maximum amount of data, generate, for display by the user interface device, a notification to indicate that the at least one text output cannot be generated.

Example 16: The computing device of example 15, wherein the notification further includes at least one suggested input associated with an amount of data that does not exceed the maximum amount of data.

Example 17: The computing device of example 15, wherein the data indicative of the user input is data indicative of a first user input, and wherein the notification further prompts a user to provide data indicative of a second user input associated with an amount of data that does not exceed the maximum amount of data.

Example 18: The computing device of any of examples 11 through 17, wherein the user input includes one or more of a text input and an audio input.

Example 19: The computing device of any of examples 11 through 18, wherein the at least one user input is a first user input associated with a session identifier, wherein the at least one text output is a first text output associated with the session identifier, and wherein the instructions further cause the one or more processors to: store the data indicative of the first user input and the first text output with the session identifier in a memory; receive data indicative of a second user input associated with the session identifier; determine whether an amount of the data indicative of the second user input exceeds the maximum amount of data; responsive to determining the amount of the data indicative of the second user input exceeds the maximum amount of data, generate modified data indicative of the second user input by applying one or more transformations to the data indicative of the second user input, wherein the one or more transformations are based on the first text output; responsive to determining an amount of the modified data indicative of the second user input does not exceed the maximum amount of data, transmit, to the computing system via the connection, the session identifier and the modified data indicative of the second user input; receive, via the connection, a second text output generated by the computing system based on the modified data indicative of the second user input; generate, for display by the user interface device, the second text output; and store the data indicative of the second user input and the second text output with the session identifier in the memory.

Example 20: The computing device of any of examples 11 through 19, wherein the at least one text output generated by the computing system is at least one modified text output generated by the computing system, and wherein an amount of data indicative of the at least one modified text output does not exceed the maximum amount of data.

Example 21: A non-transitory computer-readable storage medium encoded with instructions that, when executed by one or more processors of a computing device, cause one or more processors to: establish a connection with at least one accessible non-terrestrial network; receive data indicative of at least one user input; determine whether an amount of the data exceeds a maximum amount of data that can be transmitted via the connection within a predetermined time frame; responsive to determining the amount of the data exceeds the maximum amount of data, generate modified data by applying one or more transformations to the data indicative of the at least one user input; responsive to determining an amount of the modified data does not exceed the maximum amount of data, transmit, to a computing system via the connection, the modified data and a prompt, wherein the prompt is indicative of context information for the computing device; receive, via the connection, at least one text output generated by the computing system based on the modified data and the prompt; and generate, for display by a user interface device included in the computing device, the at least one text output.

Example 22: The non-transitory computer-readable storage medium of example 21, wherein the context information for the computing device includes one or more of: information associated with a location of the computing device, an indication of the connection with the at least one accessible non-terrestrial network, an indication of one or more wireless communications networks being outside of an accessibility range of the computing device for an amount of time, and an indication of a cellular signal strength of the computing device being below a threshold for an amount of time.

Example 23: The non-transitory computer-readable storage medium of example 22, wherein the one or more wireless communications networks include one or more of a WI-FI network and a cellular communications network.

Example 24: The non-transitory computer-readable storage medium of any of examples 21 through 23, wherein to generate the modified data by applying the one or more transformations to the data indicative of the at least one user input, the instructions further cause the one or more processors to: generate the modified data by applying a machine learning model operating in a low power mode to the data indicative of the at least one user input, wherein the one or more transformations include one or more of feature selection, data compression, data summarization, redundant data removal, approximate data processing, encoding, tokenization, data caching, and data merging.

Example 25: The non-transitory computer-readable storage medium of any of examples 21 through 24, wherein the instructions further cause the one or more processors to: responsive to determining the amount of the modified data exceeds the maximum amount of data, generate, for display by the user interface device, a notification to indicate that the at least one text output cannot be generated.

Example 26: The non-transitory computer-readable storage medium of example 25, wherein the notification further includes at least one suggested input associated with an amount of data that does not exceed the maximum amount of data.

Example 27: The non-transitory computer-readable storage medium of example 25, wherein the data indicative of the user input is data indicative of a first user input, and wherein the notification further prompts a user to provide data indicative of a second user input associated with an amount of data that does not exceed the maximum amount of data.

Example 28: The non-transitory computer-readable storage medium of any of examples 21 through 27, wherein the user input includes one or more of a text input and an audio input.

Example 29: The non-transitory computer-readable storage medium of any of examples 21 through 28, wherein the at least one user input is a first user input associated with a session identifier, wherein the at least one text output is a first text output associated with the session identifier, and wherein the instructions further cause the one or more processors to: store the data indicative of the first user input and the first text output with the session identifier in a memory; receive data indicative of a second user input associated with the session identifier; determine whether an amount of the data indicative of the second user input exceeds the maximum amount of data; responsive to determining the amount of the data indicative of the second user input exceeds the maximum amount of data, generate modified data indicative of the second user input by applying one or more transformations to the data indicative of the second user input, wherein the one or more transformations are based on the first text output; responsive to determining an amount of the modified data indicative of the second user input does not exceed the maximum amount of data, transmit, to the computing system via the connection, the session identifier and the modified data indicative of the second user input; receive, via the connection, a second text output generated by the computing system based on the modified data indicative of the second user input; generate, for display by the user interface device, the second text output; and store the data indicative of the second user input and the second text output with the session identifier in the memory.

Example 30: The non-transitory computer-readable storage medium of any of examples 21 through 29, wherein the at least one text output generated by the computing system is at least one modified text output generated by the computing system, and wherein an amount of data indicative of the at least one modified text output does not exceed the maximum amount of data.

Example 31: A computer program product for enabling information retrieval while connected with at least one accessible non-terrestrial network, the computer program product comprising one or more instructions that, when executed by one or more processors of a computing device, cause the one or more processors to: establish a connection with at least one accessible non-terrestrial network; receive data indicative of at least one user input; determine whether an amount of the data exceeds a maximum amount of data that can be transmitted via the connection within a predetermined time frame; responsive to determining the amount of the data exceeds the maximum amount of data, generate modified data by applying one or more transformations to the data indicative of the at least one user input; responsive to determining an amount of the modified data does not exceed the maximum amount of data, transmit, to a computing system via the connection, the modified data and a prompt, wherein the prompt is indicative of context information for the computing device; receive, via the connection, at least one text output generated by the computing system based on the modified data and the prompt; and generate, for display by a user interface device included in the computing device, the at least one text output.

Example 32: The computer program product of example 31, wherein the context information for the computing device includes one or more of: information associated with a location of the computing device, an indication of the connection with the at least one accessible non-terrestrial network, an indication of one or more wireless communications networks being outside of an accessibility range of the computing device for an amount of time, and an indication of a cellular signal strength of the computing device being below a threshold for an amount of time.

Example 33: The computer program product of example 32, wherein the one or more wireless communications networks include one or more of a WI-FI network and a cellular communications network.

Example 34: The computer program product of any of examples 31 through 33, wherein to generate the modified data by applying the one or more transformations to the data indicative of the at least one user input, the instructions further cause the one or more processors to: generate the modified data by applying a machine learning model operating in a low power mode to the data indicative of the at least one user input, wherein the one or more transformations include one or more of feature selection, data compression, data summarization, redundant data removal, approximate data processing, encoding, tokenization, data caching, and data merging.

Example 35: The computer program product of any of examples 31 through 34, wherein the instructions further cause the one or more processors to: responsive to determining the amount of the modified data exceeds the maximum amount of data, generate, for display by the user interface device, a notification to indicate that the at least one text output cannot be generated.

Example 36: The computer program product of example 35, wherein the notification further includes at least one suggested input associated with an amount of data that does not exceed the maximum amount of data.

Example 37: The computer program product of example 35, wherein the data indicative of the user input is data indicative of a first user input, and wherein the notification further prompts a user to provide data indicative of a second user input associated with an amount of data that does not exceed the maximum amount of data.

Example 38: The computer program product of any of examples 31 through 37, wherein the user input includes one or more of a text input and an audio input.

Example 39: The computer program product of any of examples 31 through 38, wherein the at least one user input is a first user input associated with a session identifier, wherein the at least one text output is a first text output associated with the session identifier, and wherein the instructions further cause the one or more processors to: store the data indicative of the first user input and the first text output with the session identifier in a memory; receive data indicative of a second user input associated with the session identifier; determine whether an amount of the data indicative of the second user input exceeds the maximum amount of data; responsive to determining the amount of the data indicative of the second user input exceeds the maximum amount of data, generate modified data indicative of the second user input by applying one or more transformations to the data indicative of the second user input, wherein the one or more transformations are based on the first text output; responsive to determining an amount of the modified data indicative of the second user input does not exceed the maximum amount of data, transmit, to the computing system via the connection, the session identifier and the modified data indicative of the second user input; receive, via the connection, a second text output generated by the computing system based on the modified data indicative of the second user input; generate, for display by the user interface device, the second text output; and store the data indicative of the second user input and the second text output with the session identifier in the memory.

Example 40: The computer program product of any of examples 31 through 39, wherein the at least one text output generated by the computing system is at least one modified text output generated by the computing system, and wherein an amount of data indicative of the at least one modified text output does not exceed the maximum amount of data.

Example 41: A computing system comprising means for performing any of the methods of examples 1-10.

Example 42: A method comprising receiving, by a computing system, and from a computing device via a connection with at least one accessible non-terrestrial network, a prompt and data indicative of at least one user input, wherein the prompt is indicative of context information for the computing device; applying, by the computing system, a machine learning model to the prompt and the data indicative of the at least one user input to generate data indicative of at least one output; determining, by the computing system, whether an amount of the data indicative of the at least one output exceeds a maximum amount of data that can be transmitted via the connection within a predetermined time frame; responsive to determining the amount of the data exceeds the maximum amount of data, generating, by the computing system, modified data by applying one or more transformations to the data indicative of the at least one output; and responsive to determining an amount of the modified data does not exceed the maximum amount of data, transmitting, by the computing system, and to the computing device via the connection, the modified data.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

This description, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

In accordance with the examples of this disclosure, the term “or” may be interpreted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structures or any other structure suitable for implementation of the techniques described. In addition, in some examples, the functionality described may be provided within dedicated hardware and/or software modules. Also, the techniques could be fully implemented in one or more circuits or logic elements.

What is claimed is:

1. A method comprising:
establishing, by a computing device, a connection with at least one accessible non-terrestrial network;
receiving, by the computing device, data indicative of at least one user input;
determining, by the computing device, whether an amount of the data exceeds a maximum amount of data that can be transmitted via the connection within a predetermined time frame;
responsive to determining the amount of the data exceeds the maximum amount of data, generating, by the computing device, modified data by applying one or more transformations to the data indicative of the at least one user input;
responsive to determining an amount of the modified data does not exceed the maximum amount of data, transmitting, by the computing device, and to a computing system via the connection, the modified data and a prompt, wherein the prompt is indicative of context information for the computing device;
receiving, by the computing device, and via the connection, at least one text output generated by the computing system based on the modified data and the prompt; and
generating, by the computing device, and for display by a user interface device included in the computing device, the at least one text output.

2. The method of claim 1, wherein the context information for the computing device includes one or more of:
information associated with a location of the computing device,
an indication of the connection with the at least one accessible non-terrestrial network,
an indication of one or more wireless communications networks being outside of an accessibility range of the computing device for an amount of time, and
an indication of a cellular signal strength of the computing device being below a threshold for an amount of time.

3. The method of claim 1, wherein generating the modified data by applying one or more transformations to the data indicative of the at least one user input further comprises:
generating, by the computing device, the modified data by applying a machine learning model to the data indicative of the at least one user input, wherein the one or more transformations include one or more of feature selection, data compression, data summarization, redundant data removal, approximate data processing, encoding, tokenization, data caching, and data merging.

4. The method of claim 1, the method further comprising:
responsive to determining the amount of the modified data exceeds the maximum amount of data, generating, by the computing device, and for display by the user interface device, a notification to indicate that the at least one text output cannot be generated.

5. The method of claim 4, wherein the data indicative of the user input is data indicative of a first user input, and wherein the notification further prompts a user to provide data indicative of a second user input associated with an amount of data that does not exceed the maximum amount of data.

6. The method of claim 4, wherein the notification further includes at least one suggested input associated with an amount of data that does not exceed the maximum amount of data.

7. The method of claim 1, wherein the at least one user input is a first user input associated with a session identifier, wherein the at least one text output is a first text output associated with the session identifier, wherein the method further comprises:
storing, by the computing device, the data indicative of the first user input and the first text output with the session identifier in a memory;
receiving, by the computing device, data indicative of a second user input associated with the session identifier;
determining, by the computing device, whether an amount of the data indicative of the second user input exceeds the maximum amount of data;
responsive to determining the amount of the data indicative of the second user input exceeds the maximum amount of data, generating, by the computing device, modified data indicative of the second user input by applying one or more transformations to the data indicative of the second user input, wherein the one or more transformations are based on the first text output;
responsive to determining an amount of the modified data indicative of the second user input does not exceed the maximum amount of data, transmitting, by the computing device, and to the computing system via the connection, the session identifier and the modified data indicative of the second user input;
receiving, by the computing device, and via the connection, a second text output generated by the computing system based on the modified data indicative of the second user input;
generating, by the computing device, and for display by the user interface device, the second text output; and
storing, by the computing device, the data indicative of the second user input and the second text output with the session identifier in the memory.

8. The method of claim 1, wherein the at least one text output generated by the computing system is at least one modified text output generated by the computing system, and wherein an amount of data indicative of the at least one modified text output does not exceed the maximum amount of data.

9. A computing device comprising:
one or more processors; and
one or more storage devices that store instructions, wherein the instructions, when executed by the one or more processors, cause the one or more processors to:
establish a connection with at least one accessible non-terrestrial network;
receive data indicative of at least one user input;
determine whether an amount of the data exceeds a maximum amount of data that can be transmitted via the connection within a predetermined time frame;
responsive to determining the amount of the data exceeds the maximum amount of data, generate modified data by applying one or more transformations to the data indicative of the at least one user input;
responsive to determining an amount of the modified data does not exceed the maximum amount of data, transmit, to a computing system via the connection, the modified data and a prompt, wherein the prompt is indicative of context information for the computing device;
receive, via the connection, at least one text output generated by the computing system based on the modified data and the prompt; and
generate, for display by a user interface device included in the computing device, at least one text output.

10. The computing device of claim 9, wherein the context information for the computing device includes one or more of:
information associated with a location of the computing device,
an indication of the connection with the at least one accessible non-terrestrial network,
an indication of one or more wireless communications networks being outside of an accessibility range of the computing device for an amount of time, and
an indication of a cellular signal strength of the computing device being below a threshold for an amount of time.

11. The computing device of claim 9, wherein to generate the modified data by applying the one or more transformations to the data indicative of the at least one user input, the instructions further cause the one or more processors to:
generate the modified data by applying a machine learning model to the data indicative of the at least one user input, wherein the one or more transformations include one or more of feature selection, data compression, data summarization, redundant data removal, approximate data processing, encoding, tokenization, data caching, and data merging.

12. The computing device of claim 9, wherein the instructions further cause the one or more processors to:
responsive to determining the amount of the modified data exceeds the maximum amount of data, generate, for display by the user interface device, a notification, wherein the notification includes one or more of an indication that the at least one text output cannot be generated and at least one suggested input associated with an amount of data that does not exceed the maximum amount of data.

13. The computing device of claim 12, wherein the data indicative of the user input is data indicative of a first user input, and wherein the notification further prompts a user to provide data indicative of a second user input associated with an amount of data that does not exceed the maximum amount of data.

14. The computing device of claim 9, wherein the at least one user input is a first user input associated with a session identifier, wherein the at least one text output is a first text output associated with the session identifier, and wherein the instructions further cause the one or more processors to:
store the data indicative of the first user input and the first text output with the session identifier in a memory;
receive data indicative of a second user input associated with the session identifier;
determine whether an amount of the data indicative of the second user input exceeds the maximum amount of data;
responsive to determining the amount of the data indicative of the second user input exceeds the maximum amount of data, generate modified data indicative of the second user input by applying one or more transformations to the data indicative of the second user input, wherein the one or more transformations are based on the first text output;
responsive to determining an amount of the modified data indicative of the second user input does not exceed the maximum amount of data, transmit, to the computing system via the connection, the session identifier and the modified data indicative of the second user input;
receive, via the connection, a second text output generated by the computing system based on the modified data indicative of the second user input;
generate, for display by the user interface device, the second text output; and
store the data indicative of the second user input and the second text output with the session identifier in the memory.

15. The computing device of claim 9, wherein the at least one text output generated by the computing system is at least one modified text output generated by the computing system, and wherein an amount of data indicative of the at least one modified text output does not exceed the maximum amount of data.

16. A non-transitory computer-readable storage medium encoded with instructions that, when executed by one or more processors of a computing device, cause one or more processors to:
establish a connection with at least one accessible non-terrestrial network;
receive data indicative of at least one user input;
determine whether an amount of the data exceeds a maximum amount of data that can be transmitted via the connection within a predetermined time frame;
responsive to determining the amount of the data exceeds the maximum amount of data, generate modified data by applying one or more transformations to the data indicative of the at least one user input;
responsive to determining an amount of the modified data does not exceed the maximum amount of data, transmit, to a computing system via the connection, the modified data and a prompt, wherein the prompt is indicative of context information for the computing device;
receive, via the connection, at least one text output generated by the computing system based on the modified data and the prompt; and
generate, for display by a user interface device included in the computing device, the at least one text output.

17. The non-transitory computer-readable storage medium of claim 16, wherein the context information for the computing device includes one or more of:
information associated with a location of the computing device,
an indication of the connection with the at least one accessible non-terrestrial network,
an indication of one or more wireless communications networks being outside of an accessibility range of the computing device for an amount of time, and
an indication of a cellular signal strength of the computing device being below a threshold for an amount of time.

18. The non-transitory computer-readable storage medium of claim 16, wherein to generate the modified data by applying the one or more transformations to the data indicative of the at least one user input, the instructions further cause the one or more processors to:
generate the modified data by applying a machine learning model to the data indicative of the at least one user input, wherein the one or more transformations include one or more of feature selection, data compression, data summarization, redundant data removal, approximate data processing, encoding, tokenization, data caching, and data merging.

19. The non-transitory computer-readable storage medium of claim 16, wherein the at least one user input is a first user input associated with a session identifier, wherein the at least one text output is a first text output associated with the session identifier, and wherein the instructions further cause the one or more processors to:
store the data indicative of the first user input and the first text output with the session identifier in a memory;
receive data indicative of a second user input associated with the session identifier;
determine whether an amount of the data indicative of the second user input exceeds the maximum amount of data;
responsive to determining the amount of the data indicative of the second user input exceeds the maximum amount of data, generate modified data indicative of the second user input by applying one or more transformations to the data indicative of the second user input, wherein the one or more transformations are based on the first text output;
responsive to determining an amount of the modified data indicative of the second user input does not exceed the maximum amount of data, transmit, to the computing system via the connection, the session identifier and the modified data indicative of the second user input;
receive, via the connection, a second text output generated by the computing system based on the modified data indicative of the second user input;
generate, for display by the user interface device, the second text output; and
store the data indicative of the second user input and the second text output with the session identifier in the memory.

20. The non-transitory computer-readable storage medium of claim 16, wherein the at least one text output generated by the computing system is at least one modified text output generated by the computing system, and wherein an amount of data indicative of the at least one modified text output does not exceed the maximum amount of data.
